(19) United States
(12) Patent Application Publication
(10) Pub. No.: US 2025/0370447 A1
(43) Pub. Date: Dec. 4, 2025

(54) OPTIMIZATION OF BUILDING OPERATIONS

(71) Applicant: Honeywell International Inc., Charlotte, NC (US)

(72) Inventors: Marek Sikora, Kurim (CZ); Jiri Rojicek, Praha (CZ); Ronny Scherf, Grosshernnersdorf (DE); Karthika M, Pune (IN)

(21) Appl. No.: 18/675,196

(22) Filed: May 28, 2024

(51) Int. Cl. G05B 23/02; G05B 15/02

(52) U.S. Cl. CPC G05B 23/0283; G05B 15/02; G05B 2223/02

(57) ABSTRACT

Examples techniques to manage building operations are described. A predefined range of setpoints corresponding to a key performance identifier (KPI) for an asset installed in a building is obtained. The predefined range of setpoints for the asset includes values for operating parameters of the asset to achieve a predefined ambient condition in the building. An operation of the asset is monitored over a time period to identify a deviation between values of the operating parameters of the asset from the corresponding predefined range of setpoints. Based on the deviation, a loss associated with operation of the asset in the building is estimated. A corrective action is caused to be performed to adjust the values of the operating parameters of the asset to reduce the estimated loss.

### BACKGROUND

Sustainable building operations are increasingly recognized as an important aspect of modern construction and facility management due to their impact on the environment, economy, and social well-being. Buildings are a substantial contributor to global energy consumption and greenhouse gas emissions, with large buildings, such as offices, hospitals, malls and hotels accounting for a considerable share. As such, there is a pressing demand to operate these structures in a manner that is environmentally responsible, energy-efficient, and sustainable over the long term. Sustainable building operations help in minimizing energy consumption and emissions, conserving natural resources, and promoting biodiversity. An energy-efficient building lowers operational costs, for example, by reducing energy and water usage. This translates into financial savings for building owners, managers or occupants and contributes to the economic viability of green building practices. In some cases, optimization of the building operations may become a necessity in order to comply with government regulations and guidelines put in place to promote sustainability in a built environment.

Building Management Systems (BMSs) play an important role in meeting such sustainability objectives by enabling more efficient, and safer building operations. The BMSs are advanced control systems that provide centralized management for assets, such as HVAC (heating, ventilation, and air conditioning), lighting, power systems, fire systems, and security systems, installed in a building to optimize the performance of the building by monitoring and controlling the energy usage of the assets installed in the building.

### SUMMARY

Various embodiments of systems, methods, and non-transitory computer-readable media for managing building operations are described herein.

The details of some embodiments of the subject matter described in this specification are set forth in the accompanying drawings and the description below. Other features, aspects, and advantages of the subject matter will become apparent from the description, the drawings, and the claims.

According to an embodiment of the present subject matter, a method for managing building operations is provided. According to the method, a predefined range of setpoints corresponding to a key performance identifier (KPI) for an asset installed in a building is obtained. The predefined range of setpoints for the asset includes values for operating parameters of the asset to achieve a predefined ambient condition in the building. Operation of the asset is monitored over a time period to identify a deviation of the values of the operating parameters of the asset from the corresponding predefined range of setpoints. Based on the deviation, a loss associated with operation of the asset in the building is estimated. A corrective action may be caused to be performed to adjust the values of the operating parameters of the asset to reduce the estimated loss.

According to another embodiment of the present subject matter, a system for managing building operations is provided. The system comprises a processor to monitor operation of one or more assets installed in each of a plurality of zones in a building over a period of time. Such a monitoring allows the system to determine a deviation in values of operating parameters of the one or more assets from a corresponding predefined range of setpoints. The predefined range of setpoints includes values of operating parameters of the one or more assets predefined for the time period. Based on the deviation, the processor estimates a loss associated with the operation of the one or more assets in each of the plurality of zones for the time period. The processor determines a plurality of corrective actions to reduce the estimated loss corresponding to each of the plurality of zones and may compute a reduction in the estimated loss corresponding to each of the plurality of corrective actions. The processor further initiates a corrective action selected from amongst the plurality of corrective actions. The corrective action may be selected based on the reduction in the estimated loss corresponding to each of the plurality of corrective actions.

According to yet another embodiment of the present subject matter, a non-transitory computer-readable medium comprising instructions executable by a processing resource to manage building operations is provided. The instructions, when executed, cause the processing resource to monitor operation of an HVAC system installed in a building to record values of operating parameters of the HVAC system over a time period. The instructions may also cause the processing resource to determine a deviation of the values of the operating parameters of the HVAC system from a range of setpoints predefined for the HVAC system for the time period. The range of setpoints indicate values for operating parameters of the HVAC system for the time period. The instructions further cause the processing resource to estimate, based on the deviation, a loss associated with operation of the HVAC system in the building. The instructions also cause the processing resource to cause adjustment of the values of the operating parameters of the HVAC system to reduce the estimated loss.

In accordance with example implementations of the present subject matter the techniques for managing building operations described herein, provide for estimation of loss associated with operation of one or more assets installed in a building. The techniques also recommend one or more corrective actions to reduce the estimated loss. In example embodiments, techniques may also provide an indication of return on investment (ROI) corresponding to each of the different corrective actions by estimating potential reduction in estimated loss on implementing a corrective action. Accordingly, the techniques described herein provide for making building operations efficient, which in turn enable not only monetary savings but also enhance sustainability of the building operations.

### BRIEF DESCRIPTION OF FIGURES

The following detailed description references the drawings, wherein:

FIG. 1 illustrates a network environment for implementing example techniques to manage building operations, in accordance with an example implementation of the present invention;

FIG. 2 illustrates a system to manage building operations, in accordance with an example implementation of the present invention;

FIG. 3 illustrates the system to manage building operations, in accordance with another example implementation of the present invention;

FIG. 4 illustrates a signal flow in a process to manage building operations, in accordance with an example implementation of the present invention;

FIG. 5 illustrates a method for managing building operations, according to an example of the present invention;

FIG. 6 illustrates a method for managing building operations, according to another example implementation of the present invention;

FIG. 7 illustrates a method for estimating a loss associated with operation of an asset installed in a building, according to an example of the present invention;

FIG. 8 illustrates a method for selection and implementation of a corrective action to reduce a loss associated with operation of an asset installed in a building, according to an example implementation of the present invention; and

FIG. 9 illustrates a computing environment for managing building operations, according to an example implementation of the present invention.

In the figures, the left-most digit(s) of a reference number identifies the figure in which the reference number first appears. The same numbers are used throughout the drawings to reference like features and components.

### DETAILED DESCRIPTION

Building Management Systems (BMSs) are smart automation and control systems implemented for controlling operations of various assets installed in buildings. The BMSs monitor and regulate ambient conditions of the buildings for various purposes. For example, in a residential building a BMS may be operable to ensure comfort and well-being of occupants by maintaining desired temperature, humidity and air quality a. Likewise, in a datacentre, a BMS may be operable to maintain conditions suitable for the devices located therein. For example, buildings utilize BMSs to operate heating, ventilation, and air-conditioning (HVAC) systems based on a number of parameters, such as seasonal ambient temperatures, occupancy of the buildings and the like.

A BMS may also be configured to optimize the performance of a building by monitoring and controlling the energy usage of the assets installed in the building, ensuring that the assets operate at peak efficiency. BMS collects and analyzes data from sensors and meters throughout the building, providing insights into energy consumption patterns and identifying potential areas for improvement in energy usage. This allows for continuous optimization of building operations, leading to long-term sustainability benefits.

A BMS is usually implemented as a distributed system comprising a structured network of controllers and field devices configured to achieve the desired ambient conditions in a building serviced by the BMS. These systems are conventionally configured to operate conservatively, circulating air and water at constant temperatures and flow rates to cover a broad spectrum of operating conditions. To achieve the desired ambient conditions, setpoints are defined for the assets. The “setpoints” for an asset may be understood as predefined values or a range of values for operating parameters of the asset to achieve desired ambient conditions within the building. The setpoints serve as targets to achieve and maintain a desired ambient condition in the building, for example, through regulation of the assets installed in the building. For example, setting a thermostat to 20° C. establishes a temperature setpoint for the HVAC system to operate the HVAC system to achieve and maintain the ambient temperate of the building at 20° C.

The field devices of the BMS consist of sensors that monitor the operating parameters of the assets and actuators that execute physical changes (e.g., opening valves, switching lights, etc.). The field devices provide real-time data to respective local controller in the network of controllers, which then adjust the setpoints for the operating parameters of the assets to maintain the desired ambient conditions in the building. The local controllers process the data collected by the sensors to make decisions regarding the operating parameters of the assets connected with the sensors and then send commands to the actuators to adjust the operating parameters accordingly, to achieve the desired ambient conditions based on the operation of the assets of the building.

This conservative approach often leads to the inefficient use of energy, as it does not account for the variable nature of building occupancy and weather conditions, resulting in unnecessary energy and monetary expenditure and presenting opportunities for energy and monetary savings. For example, the HVAC system, which is responsible for maintaining a comfortable climate in the building, in a conventional setup, may be configured to operate within a conservative range of settings. These settings are chosen to ensure that the HVAC system can provide adequate thermal comfort under a variety of scenarios, from low to high occupancy and during different weather conditions. However, this conservative approach means that the HVAC system may not scale its operations up or down efficiently in response to the actual demand at any given moment. Consequently, the HVAC system may continuously pump air and water at nearly uniform temperatures and flow rates, regardless of considerations, such as the weather conditions or whether all areas of the building require the same level of heating or cooling. This may lead to situations where all or some parts of the building are over-conditioned, receiving more heating or cooling than is actually needed, while other parts might be under-conditioned. The result of this lack of responsiveness is that energy is not utilized as effectively as it should be, and this creates an opportunity for savings.

To overcome such drawbacks, a building operations optimizer or system-level optimizer (hereinafter optimizer) is generally used. The optimizer enables the BMS to create an adaptive environment by continuously monitoring local conditions via a network of the sensors. These sensors gather data on various operating parameters, such as temperature, occupancy and other environmental factors. The optimizer may process the data collected by the sensors, taking into account the current operating conditions of the asset installed in the building, to determine appropriate setpoints for the asset installed in the building. Based on these setpoints, asset may be operated through respective actuators to achieve desired ambient conditions in the building.

The objective of the optimizer is to ensure that energy is utilized in the building as efficiently as possible while maintaining comfort in all areas of the building. To accomplish this, the optimizer periodically updates the setpoints that govern the operation of the assets in the building. By updating these setpoints at regular intervals, such as every 15 minutes, 2 hours, month or season, the optimizer can adjust the operations of the building assets to align with current conditions and requirements. This periodic updating allows the optimizer to respond to changes in occupancy, weather, and other factors that influence the energy demands within the building. For instance, if the occupancy of the building decreases, the optimizer can lower the temperature setpoint to reduce heating or cooling output, thereby saving energy while still keeping the environment comfortable for the remaining occupants. Similarly, if the weather changes, the optimizer system can adjust the setpoints to account for the new conditions, such as increasing cooling on an unexpected hot day.

Thus, the optimizer seeks to address the inefficiency of conventional building management systems by adjusting setpoints in response to real-time data on building occupancy and weather conditions, thereby delivering optimum amount of energy at all times to maintain the desired ambient condition in various areas of a building.

However, in buildings, there are often several personnels, such as facility managers, service teams, occupants, interacting with an asset, such as the HVAC systems. This sometimes leads to contradictory configurations, for example, simultaneous heating and cooling or settings far from optimal, such as manual overrides, invalid schedules resulting in wastage on various levels and impacting key performance identifier, such as energy consumed by the asset, asset's lifetime, cost of operation of the asset.

Further, typical maintenance operations in buildings are still focused on solving the most urgent tasks, due to usually limited capacity and capability of service teams. Buildings are significant energy consumers and fault-free building operation is essential for comfort of the occupants and the building efficiency. Reactive assessment and maintenance for isolated assets does not reveal the efficient savings opportunities, owing to the fact that, often, significant overall losses resulting from a non-optimal setting of the assets may be a sum of small contributions by individual assets. However, in the existing solutions of building management, optimal settings for the setpoints are not established taking into account overall losses which may occur as a result of non-optimal settings. Also, maintenance action by the service teams is not prioritized taking the overall losses into consideration.

According to example implementations of the present subject matter, techniques for managing building operations are described. In embodiments, managing building operations involves monitoring operation of assets installed in a building to estimate loss associated with operation of the asset. The example methods and systems for managing building operations provide for reducing the loss associated with operation of the asset through corrective actions.

In example implementations, techniques for managing building operations involves obtaining a range of setpoints that may have been predefined corresponding to a key performance identifier (KPI) for an asset installed in a building. Example, the KPI may include monetary savings, energy savings, optimizing asset's lifetime and the like. The predefined range of setpoints for the asset includes values for operating parameters of the asset to achieve a predefined ambient condition in the building. The ambient condition may include ambient temperature or humidity in the building.

According to the techniques described herein, operation of the asset is monitored over a time period to identify a deviation of values of the operating parameters of the asset from the corresponding predefined range of setpoints. Based on the deviation, a loss associated with operation of the asset in the building is estimated. In an example, the loss associated with operation of the asset may be depicted in terms of a monetary value of the loss. Such a depiction may make apparent for stakeholders, for example, occupants of the building or building operations managers, the potential savings that may be accrued by improvising the current manner of operation of the asset in the building, for instance, by implementation of one or more corrective actions, such as altering the operating parameters of the asset to eliminate or minimize the deviation of values of the operating parameters from the corresponding predefined range of setpoints. Accordingly, a corrective action is caused to be performed to adjust the values of the operating parameters of the asset to reduce the estimated loss.

Based on the estimated loss, and an estimate of reduction in loss that may be achieved corresponding to each of the alternative corrective actions, a corrective action may be selected and implemented. Further, based on the loss, maintenance activities that need to be carried out on the asset may be prioritized. Thus, the present invention optimizes the building operations, minimizes the cost or energy of running the asset and enhances the lifetime of the asset.

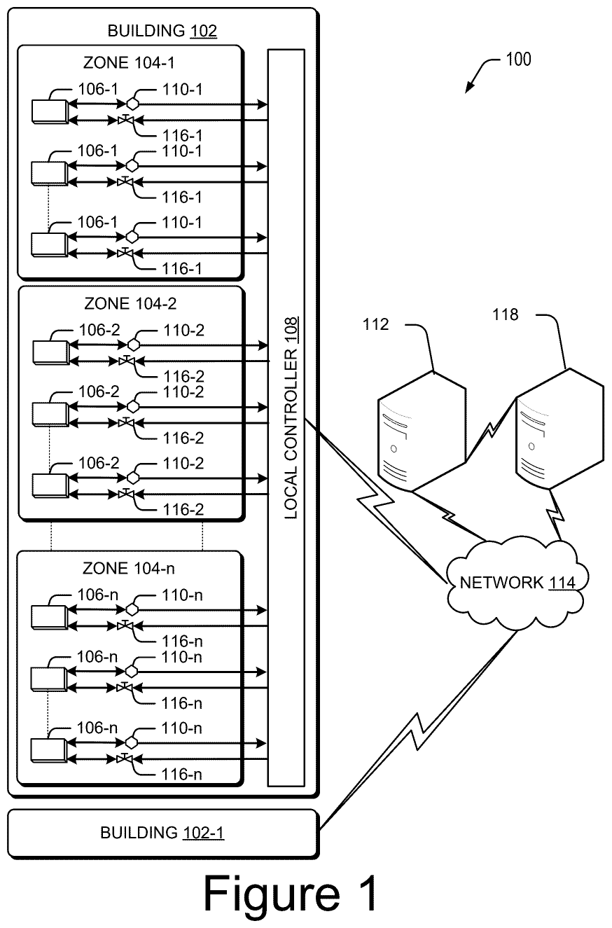

The above techniques are further described with reference to FIG. 1 to FIG. 9. It should be noted that the description and the Figures merely illustrate the principles of the present invention along with examples described herein and should not be construed as a limitation to the present invention. It is thus understood that various arrangements may be devised that, although not explicitly described or shown herein, embody the principles of the present invention. Moreover, all statements herein reciting principles, aspects, and implementations of the present invention, as well as specific examples thereof, are intended to encompass equivalents thereof.

FIG. 1 illustrates a network environment for implementing examples techniques for managing building operations, in accordance with an example implementation of the present invention.

Building operations are carried out in buildings, such as commercial offices, malls, hotels, hospitals, residential complexes, or educational institutions, to regulate ambient conditions of the buildings for various purposes, often, while addressing additional requirements, such as cost-efficient and sustainable operation of the buildings.

As buildings are designed for a wide variety of purposes, for instance, theaters may need to cater to predefined sound propagation characteristics while warehouses may need to be maintain substantially low temperature for prolonged durations of time and residential building may need to cater to comfort and well-being of occupants of the residential building, the ambient conditions of the buildings vary significantly to cater to such wide variety of purposes.

A building 102, may comprise a plurality of zones 104-1, 104-2, . . . , and 104-n. A zone of a building, such as zone 104-1 of building 102 may be a localized area of the building where ambient conditions can be regulated, such as a room, a floor or a section of a floor of the building. Each of the plurality of zones 104-1, 104-2, . . . , and 104-n, such as zone 104-1 may comprise one or more assets 106-1, 106-2, . . . , and 106-n installed therein and operated in conjunction with each other to regulate the ambient conditions of the respective zone 104-1, 104-2, . . . , and 104-n. In an example, the assets 106-1, 106-2, . . . , and 106-n installed in each of the plurality of zones 104-1, 104-2, . . . , and 104-n be operated in conjunction with each other to regulate the ambient conditions in the building 102 as a whole. A building management service provider may manage and control the building operations to be carried out in the building 102. The building management service provider may also be responsible to manage and control the building operations carried out in one or more buildings, such as buildings 102 and 102-1, for example belonging to same organization, such as one or more campuses of an educational institution, or one or more offices of an organization.

The ambient conditions within the building 102 may comprise lighting, temperature, humidity, air quality and other conditions that may be required to serve the purpose of the building 102. For example, in context of a residential complex, the ambient conditions of the building 102 may refer to conditions that influence comfort of the occupants of the building 102 such as lighting, temperature, air quality, and humidity in the building.

The “ambient conditions” within a building 102 are regulated by controlling the operating parameters of the assets 106-1, 106-2, . . . , and 106-n in the building 102 or in a zone 104-1, 104-2, . . . , and 104-n of the building. In an example, operating parameters, such as temperature and airflow settings of assets 106-1, 106-2, . . . , and 106-n, such as HVACs installed in a zone 104-1, 104-2, . . . , and 104-n of the building 102 may be regulated in accordance with demands from the occupants.

An “asset” may refer to any equipment or a collection of equipment that function as an asset 106-1, 106-2, . . . , and 106-n in the building 102. An asset, for example, may include from a single unit of an HVAC system, such as an air handler or boiler, to a complete subsystem like the HVAC system itself, which comprises multiple equipment working together to control the ambient condition in the building. The term “asset” may also extend to other control systems of the building 102, such as security systems, lighting systems, fire control systems, and/or other building control systems installed within the building, each of which may consist of individual equipment or integrated sets of equipment. The ambient conditions of the building 102 are managed such

that, achieving and maintaining the desired ambient conditions in the building 102 also account for safe operation of the assets 106-1, 106-2, . . . , and 106-n that bring about said conditions. Thus, the assets 106-1, 106-2, . . . , and 106-n installed in the building 102 are selected bearing the purpose of the building in mind. In other words, the assets 106-1, 106-2, . . . , and 106-n are selected such that the ambient conditions required to serve the purposes of the building 102 are achieved by operating the assets 106-1, 106-2, . . . , and 106-n . . . in accordance with their safe limits of operation.

For example, a cooling system for a laboratory that may need to be maintained at temperatures lower than that required in a residential complex, may be selected based on its correspondingly higher cooling capacity. As will be understood, installing a cooling system suitable for the residential complex in the laboratory, where it may be operated to achieve temperatures lower than may have been designed to achieve, may damage the cooling system. In extreme circumstances, such unsafe operation of the cooling system may also lead to fire incidences due to overheating of components of the cooling system and other safety hazards.

Thus, to ensure that ambient conditions of the building 102 account for the safety of the assets 106-1, 106-2, . . . , and 106-n, values of the operating parameters of the assets 106-1, 106-2, . . . , and 106-n are maintained within predefined safe limits of the operating parameters. In an example, the predefined safe limits of the operating parameters for each of the assets 106-1, 106-2, . . . , and 106-n may be defined by a manufacturer of the asset, for example, based on a rated capacity, design, and other factors relating to the performance capability of the asset to prevent malfunctions or damage to the assets 106-1, 106-2, . . . , and 106-n during its installation and operation in the building 102.

As discussed previously, maintaining desired ambient conditions in a building 102 involves regulating the ambient conditions regularly based on changes in factors that influence the ambient conditions. For example, maintaining desired ambient conditions in a building throughout a day, may involve altering temperature setpoints in the morning, afternoon and night.

Regulation of the ambient conditions may involve a process of monitoring and adjusting various ambient conditions, such as the lighting, temperature, air quality, and humidity, and other factors that contribute to ambient conditions of a building, such as the building 102. This regulation is usually done to respond to changes in external environmental conditions, occupancy patterns, and specific requirements of the use of the building 102. For example, the external environmental conditions, such as changes in weather, may influence the ambient conditions of the building 102 requiring adjustments to the operating parameters of the assets 106-1, 106-2, . . . , and 106-n of a zone 104-1, 104-2, . . . , and 104-n of the building 102. Additionally, the use of the building 102 may change over time, for example, an office building may become generally vacant after business hours, prompting a shift in the desired ambient conditions to conserve energy while still preventing environmental extremes that may damage the assets 106-1, 106-2, . . . , and 106-n the zone 104-1, 104-2, . . . , and 104-n of the building 102. In the case of a warehouse, type of products stored may dictate different temperature and humidity levels, which can change with the inventory.

To address these dynamic requirements, controllers that regulate the ambient conditions within the building 102, are used. A local controller 108 may be implemented to regulate the ambient conditions in each of the plurality of zones 104-1, 104-2, . . . , and 104-n of the building, for example, by controlling operation of the respective assets 106-1, 106-2, . . . , and 106-n to ensure the maintenance of predefined ambient conditions within the building 102, safety of the assets 106-1, 106-2, . . . , and 106-n, and also sustainable operation of the building 102. For example, the local controller 108 can be used to control the HVAC system to control temperature of different zones (e.g., rooms, areas, spaces, and/or floors) of the building 102. The local controller 108 may set and/or adjust various setpoints of the HVAC system, such as, supply water, air temperature, and/or air speed, among others, depending on the ambient conditions of the building 102.

The local controller 108 may be any computing device, such as a server, a desktop computer, laptop, smartphones, or a tablet. The local controller 108 may comprise one or more processors for executing instructions to control and monitor the operating parameters of the assets 106-1, 106-2, . . . , and 106-n. In an example, the processor may be implemented as microprocessors, microcomputers, microcontrollers, digital signal processors, central processing units, state machines, logic circuitries, and/or any devices that manipulate signals based on operational instructions. The local controller 106 may comprise a memory for storing the instructions executable by the one or more processor. The instructions may cause the processor to control and monitor the operating parameters of the assets 106-1, 106-2, . . . , and 106-n. The memory may include any computer-readable medium known in the art including, for example, volatile memory (e.g., RAM), and/or non-volatile memory (e.g., EPROM, flash memory, etc.). The memory may also be an external memory unit, such as a flash drive, a compact disk drive, an external hard disk drive, or the like.

In an example, to achieve a predefined ambient condition within the building 102 or a zone 104-1, 104-2, . . . , and 104-n of the building 102, operating parameters corresponding to the assets 106-1, 106-2, . . . , and 106-n-n may be determined. In an example, an operator, such as a building operations manager may set 25° C. as the temperature of the building, for example a mall, or office. To achieve said ambient condition of 25° C., the operating parameters for an asset, such as an air conditioner unit may be determined.

The local controller 108 may regulate the operation of the assets 106-1, 106-2, . . . , and 106-n by controlling the operating parameters of the assets 106-1, 106-2, . . . , and 106-n in accordance with setpoints that may be defined for the respective assets 106-1, 106-2, . . . , and 106-n to achieve the predefined ambient condition. In one example, the predefined ambient condition may be a certain level of humidity in a building. To achieve said humidity level, the local controller 106 may regulate the operation of one or more assets, such as the HVAC system by controlling the operating parameters, such as an air flow rate and water flow rate of the

HVAC system. For instance, if the desired humidity level is 45% relative humidity, the local controller 108 may adjust the air flow rate and water flow rate of the HVAC system to increase or decrease moisture in the air, thereby achieving the desired humidity level of 45% relative humidity which is the predefined ambient condition to be achieved within the building 102. Thus, setpoints may refer to the values of the operating parameters of the assets that may be predefined to achieve a desired ambient condition in the building or a zone 104-1, 104-2, . . . , and 104-n of the building that may be predefined.

Determination of setpoints for operation of the assets towards achieving predefined ambient conditions within the building may be based on one or more key performance identifiers (KPIs). A KPI may be understood as a parameter for evaluating performance of the assets 106-1, 106-2, . . . , and 106-n in the building 102. The KPI may refer to a measurable objective of building operations. A KPI may include monetary savings, energy savings, optimizing asset's lifetime, maximizing occupants' comfort and the like. For example, to comply with the objective of sustainability, a limit for carbon emission may be predefined and setpoints may be defined in accordance with the limit to meet the objective. If operations of the assets within the building are aimed at maximizing occupants' comfort, setpoints for an asset may be defined to have different values than the setpoints defined for the operations aimed at maximizing energy savings.

The operating parameters of an asset may be understood as measurable attributes of the asset that may be controlled to control an output of the asset. Examples of the operating parameters, for example, of an HVAC system, may include the supply water, the air temperature, and/or the air speed, among others, associated with various components of the HVAC system, that may be sensed, for example, by a corresponding sensor. Accordingly, one or more sensors 110-1, 110-2 . . . , and 110-n may be connected with the respective asset 106-1, 106-2, . . . , and 106-n to sense the operating parameters associated with the corresponding asset. The local controller 106 may use data from the sensors 110-1, 110-2 . . . , and 110-n, which represent a value of the corresponding operating parameters to monitor the operations of the asset 106-1, 106-2, . . . , and 106-n.

Referring to the previous example, to achieve the predefined level of humidity within building 102, the operating parameters, such as the air flow rate and water flow rate may be monitored using the sensors 110-1, 110-2 . . . , and 110-n connected with the respective asset 106-1, 106-2, . . . , and 106-n to sense the operating parameters associated with the corresponding asset 106-1, 106-2, . . . , and 106-n. The local controller 106 may use the data from the sensors 110-1, 110-2 . . . , and 110-n, which represent a value of the corresponding operating parameters, to monitor and adjust the operations of the HVAC system to achieve the predefined level of humidity.

In some cases, there may be a separate local controller 108 for each zone 104-1, 104-2, . . . , and 104-n of the building 102. For instance, each zone may have different occupancy patterns, thermal characteristics, or usage purposes, necessitating individualized control of the ambient conditions, such as the temperature, humidity, and air quality. A supervisory controller (not illustrated) that can provide instructions to a local controller of a zone 104-1, 104-2, . . . , and 104-n corresponding to the setpoints for the operating parameters of the assets 106-1, 106-2, . . . , and 106-n that control the conditions in the zone 104-1, 104-2, . . . , and 104-n.

In accordance with example implementations of the present subject matter, the local controller 108 works in conjunction with a building operations optimizer 112 (hereinafter optimizer 112) to achieve the predefined the controlled conditions. In an example, the optimizer 112 may be implemented and maintained by the building management service provider. As explained previously, the optimizer 112 is a system to determine suitable setpoints for various operating parameters of the assets 106-1, 106-2, . . . , and 106-n in each zone 104-1, 104-2, . . . , and 104-n of the building 102 for achieving the predefined desired controlled conditions in the various zone 104-1, 104-2, . . . , and 104-n of the building 102. The optimizer 112 dynamically adjusts setpoints for the operating parameters of the assets 106-1, 106-2, . . . , and 106-n, taking into account variables that can affect the ambient conditions within the building 102, for example, occupancy and weather conditions of the building 102. The optimizer 112, in an example, may use tools, such as artificial intelligence-based algorithms and data analytics to determine setpoints corresponding to each of the desired controlled conditions in a manner that the one or more KPIs are maximized.

The optimizer 112 may be a remote device that may be connected to the local controller 108 via a network 114. The local controller 108 may provide the data received from the sensors 110-1, 110-2 . . . , and 110-n to the optimizer 112. The optimizer 112 accordingly determines the range of setpoints for the assets 106-1, 106-2, . . . , and 106-n to correspond with the current occupancy and weather conditions and provides the determined setpoints to the local controller 106. Such predefined range of setpoints may be communicated via the network 114 to the local controller 108, which, in turn, operates actuators 116-1, 116-2, . . . , and 116-n to modify settings of the corresponding assets so that the operation of the assets 106-1, 106-2, . . . , and 106-n reflects the adjusted setpoints. Also, in some situations, the predefined range of setpoints for the operating parameters of one or more of the assets 106-1, 106-2, . . . , and 106-n may be provided to the local controller 108 as manual inputs. For instance, a temperature setpoint of the asset 106-1, 106-2, . . . , and 106-n, such as a manually operable value may be input to the local controller 108 by an occupant of the building.

In an example, the network 114 may be a single network or a combination of multiple networks and may use a variety of different communication protocols. The network may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN). Depending on the technology, the network 114 includes various network entities, such as gateways, routers; however, such details have been omitted for the sake of brevity of the present description.

In an example, the optimizer 112 may be, for example, a server or other computing device (not illustrated) that communicatively couples to the local controller 108, for example, via the network 114. The computing device running the optimizer 112 may be a standalone server or maybe a remote server on a cloud computing platform to which the local controller 108 may be connected over the network 114 directly or through the supervisory controller. In an embodiment, the server may be a cloud-based computing system. The computing system may include one or computing device, such as those in a distributed computing system. The optimizer 112 may comprise one or more processing units, one or more storage devices, such as memory units, for storing data and machine-readable instructions for example, applications and application programming interfaces (APIs), and other peripherals required for providing cloud computing functionality.

In accordance with example embodiments of the present subject matter, a system 118 for optimizing losses in building operations may be coupled to the optimizer 112.

The system 118 may be any computing device, such as a server, a desktop computer, laptop, smartphones, or a tablet. In another example, functionality of the system 118 may be implemented in the computing device implementing the optimizer 112. The system 118 may be configured to estimate loss associated with operation of the one or more assets 106-1, 106-2, . . . , and 106-n in each of the plurality of zones 104-1, 104-2, . . . , and 104-n by identifying instances of deviation in operating parameters of the one or more assets 106-1, 106-2, . . . , and 106-n from the predefined range of setpoints that cause the loss.

To estimate the loss, the system 118 may monitor the operation of the one or more assets 106-1, 106-2, . . . , and 106-n. Data relating to current operating parameters of the assets 106-1, 106-2, . . . , and 106-n may be collected by the respective sensors 110-1, 110-2 . . . , and 110-n may be provided by the local controller 108 to the system 118 directly or through the optimizer 112. In an example, the loss may be indicated in terms of monetary value or energy expenditure or reduction in lifetime of the asset 106-1, 106-2, . . . , and 106-n.

In an example, the loss may be estimated for the whole building, for a zone 104-1, 104-2, . . . , and 104-n of the building or a subset of zones 104-1, 104-2, . . . , and 104-n of the building. This enables to identify zones 104-1, 104-2, . . . , and 104-n of the building that contribute to maximum losses. Similarly, losses may be estimated across plurality of zones 104-1, 104-2, . . . , and 104-n of more than one building and zones 104-1, 104-2, . . . , and 104-n across the one or more buildings contributing to maximum losses may be identified. In the example of an organization comprising one or more campuses spread across several buildings as described above, the building optimizer 112 may aggregate the loss associated with operation of the one or more assets 106-1, 106-2, . . . , and 106-n in each zone 104-1, 104-2, . . . , and 104-n of all the campuses and may recommend corrective actions to reduce the estimated aggregated loss.

An appropriate corrective action, minimizing the loss may be implemented based on the loss assessment. The corrective action, for example, may comprise controlling operating parameters of at least one of the assets 106-1, 106-2, . . . , and 106-n installed in the plurality of zones 104-1, 104-2, . . . , and 104-n. For example, the temperature for a zone 104-1, 104-2, . . . , and 104-n of an office building may be set to maintained at a temperature of 25° C. However, during monitoring, it may be found that the temperature is maintained at 20° C., for example, by manual override of thermostat settings. A corrective action that a building management service provider may opt to be taken in such cases is, adjusting the values of operating parameter of the cooling system associated with the thermostat to comply with the setpoint of 25° C. For instance, the corrective action may be implemented through the system 118 that may instruct the optimizer 112 to annul the manual override. Accordingly, the optimizer 112 may alter the operating parameter of the cooling system to operate the cooling system in accordance with the setpoint of 25° C. Thus, a variety of example implementations where the system 118 may cause the corrective actions by commanding the optimizer 112 or the local controller or the actuators 116-1, 116-2, . . . , and 116-n is possible.

Another example of a corrective action may comprises notifying an operator regarding functioning of lights in an unoccupied zone 104-1, 104-2, . . . , and 104-n. For example, if during monitoring, if the lights in a currently unoccupied zone 104-1, 104-2, . . . , and 104-n of the building are identified to be working, an operator may be instructed to switch off the lights through a notification generated regarding the same. In an example, the system 118 can be preconfigured with contact information of the operator and may send message to a registered phone no. or registered email address. Similarly, in another example, the system 118 can generate a message to be displayed in a control room of the building to notify operators in the control room. The message may indicate corrective action and location of the asset on which the action is to be carried out, for instance. Thus, examples of corrective actions also include generation of notifications that may instruct operators to carry out the corrective actions.

In yet another example, a corrective action may include scheduling a maintenance operation to be carried out on at least one of the assets 106-1, 106-2, . . . , and 106-n installed in the plurality of zones 104-1, 104-2, . . . , and 104-n. If based on the monitoring, cause underlying the loss is determined to be that one or more assets require maintenance, the system 118 may schedule the maintenance operation, for example, by creating an entry in a maintenance schedule that may be maintained, for example, by the optimizer 112 for periodic maintenance of all assets that the optimizer 112 oversees. The system 118 may also schedule the maintenance operation by notifying an operator.

In some examples, the system 118 may generate a schedule for the maintenance operations of one or more assets 106-1, 106-2, . . . , and 106-n and may notify an operator of the schedule. The system 118 may generate the schedule based on a variety of factors, such as a time of the day during which the asset 106-1, 106-2, . . . , and 106-n is idle or the non-working state. For instance, for an office building, the maintenance may be scheduled after non-working hours when the assets 106-1, 106-2, . . . , and 106-n remain idle.

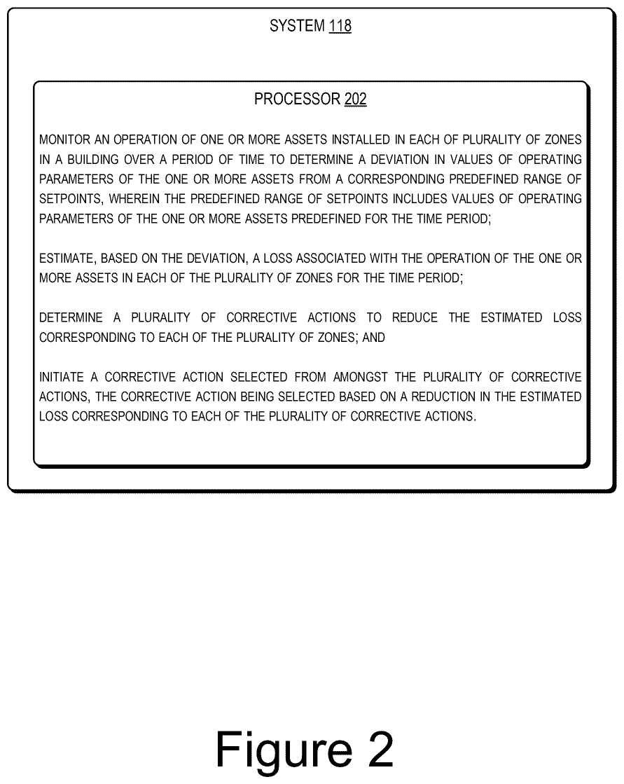

FIG. 2 shows the system 118 for managing building operations, according to an example implementation of the present subject matter. In an example, the system 118 for managing building operations controls and monitors operations of the one more assets 106-1, 106-2, . . . , and 106-n installed in each zone 104-1, 104-2, . . . , and 104-n such that losses that may be associated with operation of the one or more assets 106-1, 106-2, . . . , and 106-n are reduced.

The system 118 may be one or more computing devices, such as desktop computers, laptops, smartphones, personal digital assistants (PDAs), tablets and servers. In an example, the system 118 may comprise a processor 202. In an example, the processor 202 may be implemented as microprocessors, microcomputers, microcontrollers, digital signal processors, central processing units, state machines, logic circuitries, and/or any devices that manipulate signals based on operational instructions.

As explained previously with reference to FIG. 1, one or more assets 106-1, 106-2, . . . , and 106-n may be installed in each of plurality of zones 104-1, 104-2, . . . , and 104-n of the building. Sensors 110-1, 110-2, . . . , and 110-n may be installed in each of the plurality zones 104-1, 104-2, . . . , and 104-n to monitor operating parameters of the corresponding assets 106-1, 106-2, . . . , and 106-n. A range of setpoints for operating parameters of each of the assets 106-1, 106-2, . . . , and 106-n may be predefined, for example, by the optimizer 112. The assets 106-1, 106-2, . . . , and 106-n may be operated in accordance with the predefined range of setpoints to achieve a predefined ambient condition. The predefined ambient condition may comprise ambient temperature, air quality or humidity in the building that may be regulated by operating the one or more assets 106-1, 106-2, . . . , and 106-n. The predefined ambient conditions may be different for different time periods. For instance, temperature settings in an HVAC system defined for the daytime may be different than that defined for the nighttime. The sensors 110-1, 110-2, . . . , and 110-n may also monitor ambient conditions of the plurality of zones 104-1, 104-2, . . . , and 104-n of the building.

In an example, the processor 202 of the system 118 monitors operation of one or more assets 106-1, 106-2, . . . , and 106-n installed in each of plurality of zones 104-1, 104-2, . . . , and 104-n in a building 102 over a period of time to determine a deviation in values of operating parameters of the one or more assets 106-1, 106-2, . . . , and 106-n from a corresponding predefined range of setpoints. As described above, the predefined range of setpoints includes values of operating parameters of the one or more assets 106-1, 106-2, . . . , and 106-n predefined for the time period. To monitor operation of the one or more assets 106-1, 106-2, . . . , and 106-n, the system 118 may receive data relating to operating parameters of the one or more assets 106-1, 106-2, . . . , and 106-n and the data relating to current ambient condition of each of the plurality of zones 104-1, 104-2, . . . , and 104-n of the building 102 as collected by the sensors 110-1, 110-2, . . . , and 110-n. In an example, the local controller 108 may receive the data from the sensors 110-1, 110-2, . . . , and 110-n and provide the same to the system 118. Based on the deviation, the processor 202 of the system 118 may estimate a loss associated with the operation of the one or more assets 106-1, 106-2, . . . , and 106-n in each of the plurality of zones 104-1, 104-2, . . . , and 104-n for the time period. In an example, the loss may be characterized in terms of monetary value, energy expenditure or reduction in lifetime of the asset 106-1, 106-2, . . . , and 106-n.

The processor 202 of the system 118 may then determine a plurality of corrective actions to reduce the estimated loss corresponding to each of the plurality of zones 104-1, 104-2, . . . , and 104-n. In an example, the correction may comprise controlling operating parameters of at least one of the assets 106-1, 106-2, . . . , and 106-n installed in the plurality of zones 104-1, 104-2, . . . , and 104-n or scheduling a maintenance operation to be carried out on at least one of the assets 106-1, 106-2, . . . , and 106-n installed in the plurality of zones 104-1, 104-2, . . . , and 104-n.

In accordance with example implementations of the present subject matter, the processor 202 also computes a reduction in the estimated loss corresponding to each of the plurality of corrective actions. A corrective action from the plurality of corrective actions may be selected based on the reduction in the estimated loss corresponding to each of the plurality of corrective actions. In an example, a corrective action corresponding to which the reduction in loss in maximal may be selected.

The processor 202 may further initiate the corrective action selected from amongst the plurality of corrective actions. Accordingly, the loss associated with operation of the assets 106-1, 106-2, . . . , and 106-n according to a non-optimal settings may be minimized.

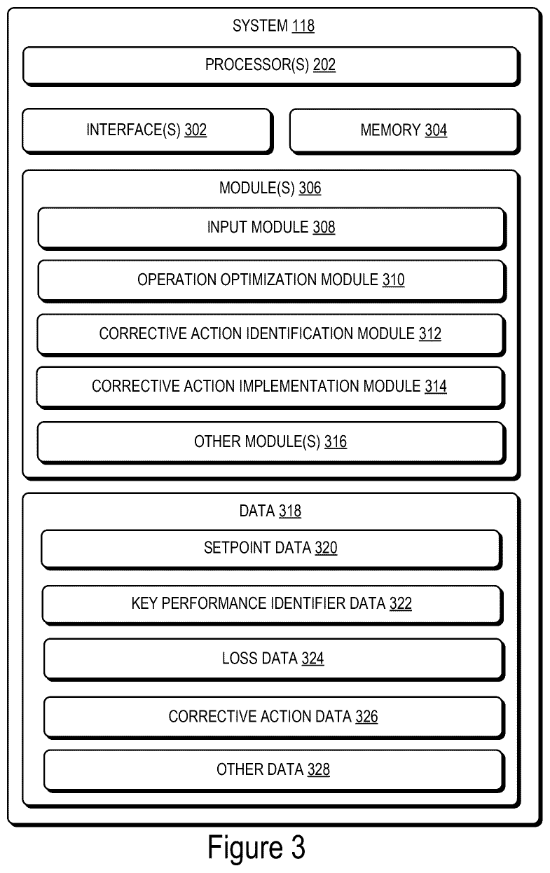

FIG. 3 illustrates the system 118 according to another example implementation of the present subject matter. In an example, the system 118 may be any computing device, such as servers, desktop computers, laptops, smartphones, personal digital assistants (PDAs), and tablets.

In an example, the system 118 comprises a processor, such as the above-described processor 202. In an example, the processor 202 may be implemented as microprocessors, microcomputers, microcontrollers, digital signal processors, central processing units, state machines, logic circuitries, and/or any devices that manipulate signals based on operational instructions. The system 118 also comprises interface(s) 302 coupled to the processor 202. The interface(s) 302 may include a variety of software and hardware interfaces that allow interaction of the system 118 with other communication and computing devices, such as network entities, web servers, and external repositories, and peripheral devices. For example, the interface(s) 302 may couple the system 118 with the building operations optimizer 112 or the local controller 108. The interface(s) 302 may also enable coupling of internal components of the system 118 with each other.

Further, the system 118 comprises a memory 304 coupled to the processor 202. The memory 304 may include any computer-readable medium known in the art including, for example, volatile memory (e.g., RAM), and/or non-volatile memory (e.g., EPROM, flash memory, etc.). The memory may also be an external memory unit, such as a flash drive, a compact disk drive, an external hard disk drive, or the like. The system 118 may comprise module(s) 306 and data 318 coupled to the processor 202.

In one example, the module(s) 306 and data 318 may reside in the memory 304.

In an example, the data 318 may comprise a setpoint data 320, key performance identifier data 322, loss data 324, corrective action data 326, and other data 328. The module(s) 306 may include routines, programs, objects, components, data structures, and the like, which perform particular tasks or implement particular abstract data types. The module(s) 306 further includes modules that supplement applications on the system 118, for example, modules of an operating system. The data 318 serves, amongst other things, as a repository for storing data that may be fetched, processed, received, or generated by one or more of the module(s) 306. The module(s) 306 may include an input module 308, an operation optimization module 310, a corrective action identification module 312, a corrective action implementation module 314 and other module(s) 316. The other module(s) 316 may include programs or coded instructions that supplement applications and functions, for example, programs in the operating system of the system 118.

As explained previously with reference to FIG. 1, the system 118 manages building operations. A building, such as the building 102 illustrated in FIG. 1, may comprise plurality of zones 104-1, 104-2, . . . , and 104-n and each zone of the building 102 may comprise one or more assets 106-1, 106-2, . . . , and 106-n installed therein to carry out building operations. Examples of building operations involve lighting control, HVAC, energy supply, water management, fire detection and control, security and access control, environment control, renewable energy production, smoke control and the like. The building operations are carried out in the building 102 to maintain desired ambient conditions within the building 102. Ambient conditions within the building 102 may include lighting, temperature, air quality or humidity in the building 102. The ambient conditions of the building 102 vary with respect to external weather conditions, occupancy patterns of the building, usage purpose of the building or other factors that influence the ambient conditions of the building 102. Thus, to maintain desired ambient condition within the building 102 or a zone 104-1, 104-2, . . . , and 104-n of the building 102, the ambient conditions need to be regulated in response to a change in these factors.

To regulate the ambient conditions of the building 102 or a zone 104-1, 104-2, . . . , and 104-n of the building 102, the local controller 108 controls and monitors the operation of one or more assets 106-1, 106-2, . . . , and 106-n installed therein. To achieve an ambient condition within the building that may be predefined, the local controller 108 controls operating parameters of the one or more assets 106-1, 106-2, . . . , and 106-n in accordance with setpoints. The one or more sensors 110-1, 110-2, . . . , and 110-n installed in each zone 104-1, 104-2, . . . , and 104-n of the building 102 may sense corresponding operating parameters of the one or more assets 106-1, 106-2, . . . , and 106-n and provide data indicative of values of the corresponding parameter to the local controller 108. The local controller 108 may monitor the operation of the one or more assets 106-1, 106-2, . . . , and 106-n using the data received from the one or more sensors 110-1, 110-2, . . . , and 110-n. The setpoints may refer to values of the operating parameters of the assets 106-1, 106-2, . . . , and 106-n that may be predefined to achieve an ambient condition within the building 102 or a zone 104-1, 104-2, . . . , and 104-n of the building 102. In an example, a “setpoint” of an operating parameter of an asset 106-1, 106-2, . . . , and 106-n may be either a value (single value) or a pair of values corresponding to minimum and maximum bound. For example, the setpoint for operating parameter of an asset 106-1, 106-2, . . . , and 106-n, such as and HVAC can be defined as 25° or a range of values comprising a maximum and minimum limits can be defined as 20 and 30 degrees. The optimizer 112 may determine the setpoints or range of setpoints to achieve the predefined ambient condition within the building based on multiple factors, such as external weather conditions, occupancy patterns and usage purpose of the building 102 or other factors that may influence the ambient conditions inside the building 102.

To achieve the predefined ambient conditions, the setpoints may be determined by the optimizer 112 based on one or more KPI(s). The operations of building may be defined with respect to one or more KPIs that may be predefined, for example by the building operations service provider. The KPI may be a measurable objective that characterizes building operations performed to maintain the predefined ambient conditions within the building 102. The objective may be sustainability, cost-saving, maximizing comfort of the occupant for example. A KPI value may be defined corresponding to each objective and the setpoints are defined in accordance with corresponding KPI. As will be understood, to achieve the one or more predefined KPIs, the assets 106-1, 106-2, . . . , and 106-n in the building 102 may be operated in accordance with the predefined KPIs. For example, for sustainability, the building operations may be configured to achieve a KPI, such as a not exceeding a predefined substantially small quantity of carbon emissions. To allow fast heating and cooling of the building to ensure maximized comfort to occupants, the building operations may be configured to achieve KPIs of predefined high output of the assets 106-1, 106-2, . . . , and 106-n. Similarly, for cost saving, the building operations may be configured to achieve KPIs, i.e., predefined low output of the assets 106-1, 106-2, . . . , and 106-n.

To achieve a predefined KPI, the assets 106-1, 106-2, . . . , and 106-n involved in creating a desired ambient condition in the building 102 may have to be operated in accordance with constraints associated with the predefined KPI. For instance, when the KPI is sustainability, an asset 106-1, 106-2, . . . , and 106-n, such as a motor of an HVAC system may not be operated above a certain level of torque if it results in a value of carbon emissions being greater than what is prescribed for the predefined KPI. However, when the KPI is ensuring maximized comfort to occupants, the motor of the HVAC system may be operated at higher torque to enable a fast rate of cooling even if such an operation of the motor causes the prescribed value of carbon emissions to exceed. The values of the operating parameters of the asset 106-1, 106-2, . . . , and 106-n are thus set in accordance with the predefined KPI, and a predefined range of values may be defined for each of the operating parameters of the asset 106-1, 106-2, . . . , and 106-n to meet the KPI(s).

In accordance with example embodiments of the present subject matter, the building operations may be optimized to satisfy more than one KPI simultaneously. For example, the assets 106-1, 106-2, . . . , and 106-n in the building 102 may be operated such that a predefined level of comfort for the occupants is assured while also complying with a threshold cost and sustainability mandates of operating the assets 106-1, 106-2, . . . , and 106-n. The values of the operating parameters of the asset 106-1, 106-2, . . . , and 106-n are thus set in accordance with the predefined set of KPIs.

In accordance with example implementations of the present subject matter, the one or more sensors 110-1, 110-2, . . . , and 110-n installed in each zone 104-1, 104-2, . . . , and 104-n of the building 102, in addition to the operating parameters of the one or more assets 106-1, 106-2, . . . , and 106-n installed therein, may also sense the ambient conditions within the building 102 or respective zone 104-1, 104-42, . . . , and 104-n. The local controller 108 may provide data including the values of the operating parameters of the assets 106-1, 106-2, . . . , and 106-n, data related to the ambient conditions within the building 102 or zone 104-1, 104-2, . . . , and 104-n of the building 102, data related to factors that influence ambient conditions of the building 102 such as occupancy patterns and external weather conditions to the optimizer 112 over the network 114. The optimizer 112 may determine the setpoints based on the data received from the local controller 108 and provide the setpoints to the local controller 108. The local controller 108 may control the operating parameters of the one or more assets 106-1, 106-2, . . . , and 106-n through corresponding actuators 116-1, 116-2, . . . , and 116-n.

In an example implementation, the input module 308 of the system 118 may obtain a predefined range of setpoints corresponding to a KPI defined for the building operations from the building optimizer 112. In another example, the input module 308 may also receive the setpoints from a system implementing an AI model to determine the setpoints based on historic data related to past operation of the one or more assets 106-1, 106-2, . . . , and 106-n. The system implementing the AI model may be connected to the system 118 for managing building operations via network 114. The predefined range of setpoints may be stored in the setpoint data 320. The input module 308 may provide the setpoints data 320 to the operation optimization module 310.

In accordance with example implementations of the present subject matter, the operation optimization module 310 may monitor the operation of the one or more assets 106-1, 106-2, . . . , and 106-n installed in each of the plurality of zones 104-1, 104-2, . . . , and 104-n in the building 102 over a period of time to determine a deviation in values of operating parameters of the one or more assets 106-1, 106-2, . . . , and 106-n from the corresponding predefined range of setpoints. As mentioned above, the predefined range of setpoints includes values of operating parameters of the one or more assets 106-1, 106-2, . . . , and 106-n predefined for the time period. In an example, to monitor the operation of the assets 106-1, 106-2, . . . , and 106-n in a zone 104-1, 104-2, . . . , and 104-n, the system 118 may receive the data indicative of operating parameters of the one or more assets 106-1, 106-2, . . . , and 106-n as sensed by the sensors 110-1, 110-2, . . . , and 110-n either from the optimizer 112 or from the local controller 108. The data may be indicative of a real-time or near real-time operational status of the assets 106-1, 106-2, . . . , and 106-n in respective zone 104-1, 104-2, . . . , and 104-n over the period of time. The local controller 108 collects the data from the sensors 110-1, 110-2, . . . , and 110-n, and may transmit this data over the network 114 to the system 118 directly or via the optimizer 112.

In accordance with example implementations of the present subject matter, the operation optimization module 310 compares the data indicative of values of operating parameters of the one or more assets 106-1, 106-2, . . . , and 106-n as received during the period of time with the corresponding predefined range of setpoints as received from the input module 308. For example, temperature of a zone 104-1, 104-2, . . . , and 104-n of a building 102 is set to be maintained at 25° C. by setting a thermostat associated with a cooling system or HVAC system to 25° C., while the temperature setting of the thermostat is found to be 20° C., for example by a manual override of thermostat setting by the occupant. Thus, a deviation of 5° C. is identified during the period of time, for example, 5 hrs.

In an example implementation, based on the deviation identified during the time period, the operation optimization module 310 may estimate a loss associated with the operation of the one or more assets 106-1, 106-2, . . . , and 106-n in each of the plurality of zones 104-1, 104-2, . . . , and 104-n for the time period. In an example, the loss may be estimated in terms of monetary value, energy expenditure or lifetime of the asset 106-1, 106-2, . . . , and 106-n.

In accordance with example implementations of the present subject matter, to estimate the loss associated with operation of an asset 106-1, 106-2, . . . , and 106-n, the operation optimization module 310 may identify a magnitude of the deviation in values of the operating parameters of the asset 106-1, 106-2, . . . , and 106-n from corresponding predefined range of setpoints. The operation optimization module 310 may also identify a duration of the time period during which the values of the operating parameters of the asset 106-1, 106-2, . . . , and 106-n deviate from the corresponding predefined range of setpoints. For a unit deviation, a loss may be predefined using an AI model or statistical techniques that may utilize historic data related to operation of the respective asset 106-1, 106-2, . . . , and 106-n to determine the same. For instance, in case of the above example of 5° C. of deviation in temperature of the zone 104-1, 104-2, . . . , and 104-n, 1° C. of deviation in temperature may require, for example, 1 KW of power of an equivalent energy of 1 kWh or 3600 KJ and thus, resulting in unit loss of 3600 KJ of energy per hour which may also be translated into an equivalent monetary value. The AI model or statistical techniques for the determination of unit loss may be implemented in the system 118 itself or in the optimizer 112. In an example, the functionality of the determination of unit loss based on AI model and statistical techniques may also be implemented in the operation optimization module 310.

The operation optimization module 310 may obtain unit loss associated with per unit deviation. In an example, the input module 308 of the system 118 may receive the unit loss associated with per unit from the optimizer 112 or based on a manual input from a user of the system 118.

The operation optimization module 310 may obtain the unit loss from the input module 308.

Accordingly, loss associated with operation of the asset 106-1, 106-2, . . . , and 106-n may be estimated based on the magnitude of deviation in values of the operating parameters of the asset 106-1, 106-2, . . . , and 106-n, the duration of time for which the values of the operating parameters deviate from the corresponding predefined range of setpoints and the unit loss associated with per unit of deviation. Thus, in the above example, loss associated with the operation of HVAC system may be 25 kWh of energy. In an example, to estimate the loss associated with operation of the asset 106-1, 106-2, . . . , and 106-n, a monetary loss associated with operation of the asset 106-1, 106-2, . . . , and 106-n in the building for the time period may be computed. For instance, in case of above example, the power required to operate the asset 106-1, 106-2, . . . , and 106-n may be translated to an equivalent monetary value based on a tariff or cost of the power or fuel.

In accordance with example embodiment of the present subject matter, the loss may also be estimated based on non-compliance with a scheduled operating time predefined for the asset 106-1, 106-2, . . . , and 106-n. For instance, one or more assets 106-1, 106-2, . . . , and 106-n, such as lights or HVAC system installed in a zone 104-1, 104-2, . . . , and 104-n of an office building may need to be operated during certain hours of the day only and a schedule may be defined for their operation accordingly. However, during monitoring, it is revealed that the assets 106-1, 106-2, . . . , and 106-n are operational beyond their scheduled hours of operation also. Such non-compliance with the scheduled operating time, may be identified as deviation in the setpoint for operating schedule of the one or more assets 106-1, 106-2, . . . , and 106-n may result in substantial loss. In such a case, loss may be estimated based on the duration of time for which the one or more assets 106-1, 106-2, . . . , and 106-n operated outside scheduled operating time and cost of operating said assets for unit time, for example, operating cost per second or per minute or per hour may be computed. The operating cost or the loss may be expressed in terms of energy expenditure or energy expenditure translated into monetary value.

In another example, according to the setpoint, in a good state of health, time expected for an asset 106-1, 106-2, . . . , and 106-n to achieve a setpoint or a parameter defined in setpoint, may be used as a basis to compute the loss. For example, to attain a predefined ambient temperature, for instance, of 25° C. an asset 106-1, 106-2, . . . , and 106-n, such as an HVAC system may be expect to take 5 minutes based on the cooling capacity of the HVAC system. However, the actual time taken by the HVAC system to attain the temperature of 25° C. may be found to be 7 min. Thus, a deviation of 2 min is identified. Such a deviation in expected time is indicative of losses owing to factors, such as poor health or a malfunction in the asset 106-1, 106-2, . . . , and 106-n that cause the deviation in the expected time. Thus, the loss may also be estimated based on determining a deviation in amount of time taken by the asset 106-1, 106-2, . . . , and 106-n to reach the corresponding predefined range of setpoint from an expected amount of time and a cost to operate the asset 106-1, 106-2, . . . , and 106-n for the extra time taken by the asset 106-1, 106-2, . . . , and 106-n. Such losses may be computed by operation optimization module 310, for example, based on inputs from users and/or by employing statistical models.

In an example, the operation optimization module 310 may store the loss associated with operation the one or more assets 106-1, 106-2, . . . , and 106-n of each of the plurality of zones 104-1, 104-2, . . . , and 104-n in loss data 324 of the data 318 of the system 118.

In accordance with example implementations of the present subject matter, based on the loss associated with operation of the asset 106-1, 106-2, . . . , and 106-n as estimated for the time period, the operation optimization module 310 may also compute a monetary loss associated with operation of the asset 106-1, 106-2, . . . , and 106-n in the building for a predetermined duration of time in future. For example, based on the pattern of operation of assets 106-1, 106-2, . . . , and 106-n in the month of June, the loss that may be accrued over summer of that year, if the assets 106-1, 106-2, . . . , and 106-n were to continue to be operated in the similar manner, may be estimated. Accordingly, the loss associated with an asset 106-1, 106-2, . . . , and 106-n thus estimated gives the service personnels, occupants or building operations managers an insight into how to achieve monetary savings.

Further in some example embodiments, the operation optimization module 310 may provide a notification on a display of the system 118 or a display device associated with the control room to indicate potential savings that may be made by improving the manner in which the assets 106-1, 106-2, . . . , and 106-n are operated in the building. For instance, the notification may be a message displaying potential savings possible by complying with the scheduled operating time predefined for the assets 106-1, 106-2, . . . , and 106-n.

Having estimated the loss associated with operation of the one or more assets 106-1, 106-2, . . . , and 106-n installed in each of the plurality of zones 104-1, 104-2, . . . , and 104-n, an aggregated loss associated with the operation of a subset of the plurality of assets 106-1, 106-2, . . . , and 106-n in each zone 104-1, 104-2, . . . , and 104-n may be computed. The subset of assets 106-1, 106-2, . . . , and 106-n may comprise the assets 106-1, 106-2, . . . , and 106-n, operating parameters of which are identified to be deviated from corresponding predefined range of setpoints during the period of time for which the operation of the one or more assets 106-1, 106-2, . . . , and 106-n is monitored. The aggregated loss thus computed corresponding to each zone 104-1, 104-2, . . . , and 104-n may also be stored in the loss data 324.

In another example, the operation optimization module 310, based on the loss associated with the operation of the one or more assets 106-1, 106-2, . . . , and 106-n in each of the plurality of zones 104-1, 104-2, . . . , and 104-n, may compute an aggregated loss associated with the operation of a subset of the plurality of zones 104-1, 104-2, . . . , and 104-n in the building. The subset of zones 104-1, 104-2, . . . , and 104-n may comprise the zones, operating parameters of the assets 106-1, 106-2, . . . , and 106-n installed wherein, are identified to be deviated from corresponding predefined range of setpoints during the period of time for which the operation of the assets 106-1, 106-2, . . . , and 106-n is monitored. The aggregated loss thus computed across the plurality of zones 104-1, 104-2, . . . , and 104-n may also be stored in the loss data 324.

In an example implementation, the corrective action identification module 312 may fetch the loss associated with operation of one or more assets 106-1, 106-2, . . . , and 106-n installed in each of the plurality of zones 104-1, 104-2, . . . , and 104-n and the aggregated loss corresponding to each zone 104-1, 104-2, . . . , and 104-n from the loss data 324. In some example embodiments, the corrective action identification module 312 may display the loss on the display of the system 118 or a display device associated with the control room.

In accordance with example implementations of the present subject matter, the corrective action identification module 312 may determine and recommend a plurality of corrective actions to reduce the estimated loss corresponding to each of the plurality of assets 106-1, 106-2, . . . , and 106-n installed in each zone 104-1, 104-2, . . . , and 104-n. A corrective action to reduce the estimated loss associated with operation of an asset 106-1, 106-2, . . . , and 106-n may comprise scheduling a maintenance operation to be carried out on the asset 106-1, 106-2, . . . , and 106-n, varying the operating parameters of the asset 106-1, 106-2, . . . , and 106-n and switching off or on the asset 106-1, 106-2, . . . , and 106-n. For example, in the previous example of deviation in temperature setting of a thermostat, the corrective action may comprise varying the temperature setting of the thermostat. In another example, an alert may be generated to notify a service personnel or operator about the change in temperature setting of the thermostat. In another example described above, wherein the actual time taken by the HVAC system to attain an ambient temperature of 25° C. is found to be deviated by 2 min from the expected time defined in the setpoint, the corrective action may include scheduling a maintenance operation for the asset 106-1, 106-2, . . . , and 106-n. In case of an office building, the maintenance may be scheduled during non-working hours. The corrective action identification module 312 may also determine a plurality of corrective actions to reduce the estimated loss corresponding to each of the plurality of zones 104-1, 104-2, . . . , and 104-n. The corrective action identification module 312 may store data related to the plurality of corrective actions recommended for reducing the loss associated with the operation of the one or more assets 106-1, 106-2, . . . , and 106-n installed in each of the plurality of zones 104-1, 104-2, . . . , and 104-n and the plurality of corrective actions recommended to reduce the loss corresponding to each of the plurality of zones 104-1, 104-2, . . . , and 104-n in the corrective action data 326.

The corrective action identification module 312 may further estimate a reduction in the estimated loss corresponding to each of the plurality of corrective actions. In an example, the corrective action identification module 312 may compute a monetary value of the reduction in the estimated loss corresponding to the corrective action. In the above example of deviation in temperature, corrective action of adjusting temperature setting in thermostat may result in monetary savings equivalent to the monetary value of 25 kWh of energy.

In accordance with example implementations of the present subject matter, the corrective action identification module 312 may also compute, for the plurality of corrective actions recommended for reducing estimated loss associated with operation of an asset 106-1, 106-2, . . . , and 106-n in a zone 104-1, 104-2, . . . , and 104-n of a building 102, a cost to implement each of the plurality of corrective actions. For example, for the corrective action of carrying out a maintenance operation on an asset 106-1, 106-2, . . . , and 106-n, a cost to implement the corrective action may involve amount to be paid to service personnel, cost of asset 106-1, 106-2, . . . , and 106-n if the asset 106-1, 106-2, . . . , and 106-n needs to be replaced or cost of one or more component of the asset 106-1, 106-2, . . . , and 106-n, that may need to be replaced.

In accordance with example implementations of the present subject matter, the corrective action identification module 312 may select a corrective action from amongst the plurality of corrective actions, based on the reduction in the estimated loss corresponding to each of the plurality of corrective actions and a cost to implement each of the plurality of corrective actions. For instance, in the example described above, wherein the loss occurred as result of deviation of 2 min in time taken by the HVAC system to attain the ambient temperature of 25° C. from the expected time defined in the setpoint, the corrective action may include carrying out a maintenance operation on the HVAC system. If the cost to implement maintenance operation is considerably higher than the loss that may occur during the operation of the HVAC system for a duration of time, for example, 2 years in future, then the corrective action of maintenance may not be selected.

In an example, the corrective action identification module 312 may also compute a reduction in the estimated loss associated with implementing each of the plurality of corrective actions for a predetermined duration of time in future. The corrective action identification module 312 may further select the corrective action from amongst the plurality of corrective actions, based on the reduction in the estimated loss associated with implementing each corrective action for the predetermined duration of time in future. For instance, a given corrective action may be cost-intensive to implement. However, once implemented, the corrective action may account for significant savings in a predetermined time in future, for example, two years. Such a corrective action may be chosen for implementation despite the initial cost associated with its implementation.

To estimate savings that may be accrued from implementing a corrective action in a given amount of time in future, an estimate of change in operating conditions that may occur due to the corrective action may be made. Thus, if the corrective action involves replacement of a faulty component of an asset 106-1, 106-2, . . . , and 106-n, the operating parameters associated with such a component may be considered to comply with the predefined values. Similarly, if the corrective action involves replacement of the asset 106-1, 106-2, . . . , and 106-n itself, the values of the operating parameters to be considered for computation of the savings may be those of a similar new asset's as defined in the manufacturer's specification.

In an example, the corrective action identification module 312 may store the corrective actions selected to reduce the loss associated with operation of the one or more assets 106-1, 106-2, . . . , and 106-n installed in plurality of zones 104-1, 104-2, . . . , and 104-n in the corrective action data 326.

In accordance with example implementations of the present subject matter, the corrective action identification module 312 may identify, based on the loss associated with the operation of the one or more assets 106-1, 106-2, . . . , and 106-n in each of the plurality of zones 104-1, 104-2, . . . , and 104-n, a zone corresponding to a highest loss. Identifying one or more zones 104-1, 104-2, . . . , and 104-n that make significant contribution to the losses may help the building management service provider to prioritize the corrective actions, such as maintenance operations to be carried out in such zones 104-1, 104-2, . . . , and 104-n to reduce the loss corresponding to these zones 104-1, 104-2, . . . , and 104-n.

In an example implementation, the system 118 may include the corrective action implementation module 314 configured to implement the selected corrective action. To implement the selected corrective action, the corrective action implementation module 314 may instruct the optimizer 112 or the local controller 108. In an example, if the selected corrective action comprises adjusting operating parameters of an asset 106-1, 106-2, . . . , and 106-n, then the corrective action implementation module 314 may instruct the optimizer 112 or the local controller 108 to adjust the operating parameters of the asset 106-1, 106-2, . . . , and 106-n. The optimizer 112 may update the setpoint data 320 to include the adjusted values of the operating parameters and provide the setpoints data to the local controller 108. The local controller 108 may then operate the actuators 116-1, 116-2, . . . , and 116-n to modify the settings of the asset 106-1, 106-2, . . . , and 106-n in accordance with the adjusted values of the operating parameters of the asset 106-1, 106-2, . . . , and 106-n. The corrective action implementation module 314 may also be operable to operate the actuators 116-1, 116-2, . . . , and 116-n to modify the settings of the asset 106-1, 106-2, . . . , and 106-n to reflect the adjusted values of the operating parameters of the asset 106-1, 106-2, . . . , and 106-n.

In accordance with example implementations of the present subject matter, upon completion of the selected corrective action, the operation optimization module 310 may monitor the operation of each of the one or more assets 106-1, 106-2, . . . , and 106-n and may compare the operation of each of the one or more assets 106-1, 106-2, . . . , and 106-n prior to the completion of the selected corrective action with operation of each of the one or more assets 106-1, 106-2, . . . , and 106-n post the completion of the selected corrective action. The operation optimization module 310 may then determine a reduction in the estimated loss corresponding to selected corrective action to verify the outcome of the selected corrective action. The operation optimization module 310 may alter the plurality of corrective actions based on the verification. For instance, consider a situation where the selected corrective action suggests altering operating parameters of a given asset 106-1, 106-2, . . . , and 106-n. For instance, RPM of a motor of a HVAC may be increased as a corrective action to achieve better cooling. Upon having implemented the corrective action, for example, after operating the motor at higher RPM for an amount of time, if desired cooling is not achieved, it may be assessed that that motor is not operating properly and an alternate corrective action of servicing the motor may further be suggested in such situations.

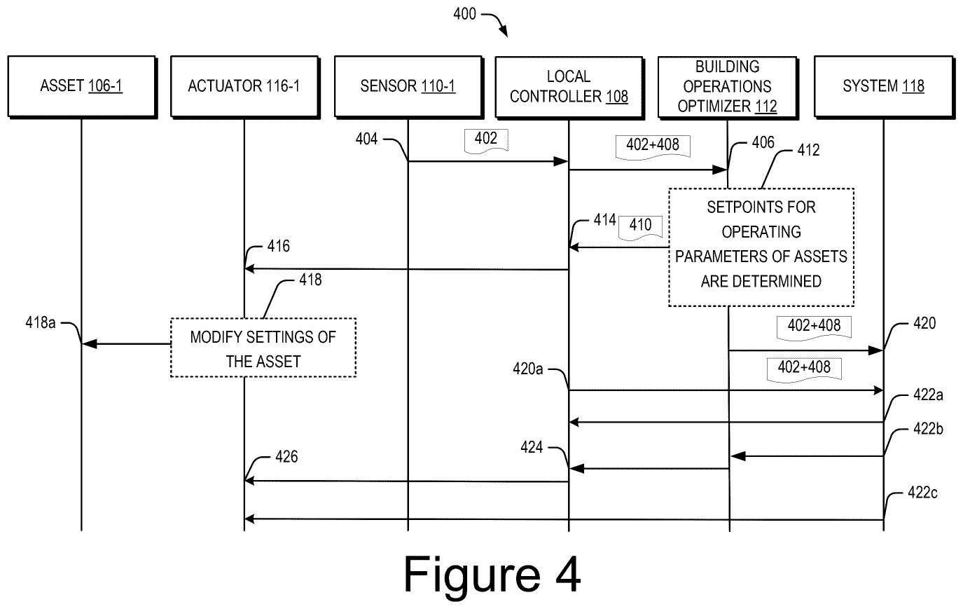

FIG. 4 illustrates a signal flow in a process to manage building operations. As described with reference to FIG. 3, building operations are carried out to maintain and regulate ambient conditions that may include temperature, humidity, air quality, or lighting, within a building, such as the building 102 or a zone, such as the zone 104-1 of the building 102. The ambient conditions may vary based on various factors such as external weather conditions, occupancy patterns of the building, usage of the building 102, or other factors that influence the ambient conditions of the building 102. To regulate the ambient conditions, operating parameters of one or more assets, such as the asset 106-1 installed within the building 102 or a zone 104 of the building 102 may be controlled by a local controller, such as the local controller 108 in accordance with setpoints. The setpoints define values of the operating parameters to achieve the ambient condition that may be predefined.

In an example implementation, the one or more sensors, such as the sensor 110-1, installed in the building 102, or the zone 104-1 of the building 102 may sense the operating parameters of the asset 106-1 installed in the zone 104-1 of the building 102, and the ambient conditions within the building 102 or the zone of the building 102. The sensor 110-1 installed in zone 104-1 of the building 102 may provide data 402 indicative of values of the corresponding operating parameters of the asset 106-1 and the ambient conditions to the local controller 108 as represented through signal 404. The local controller 108 may provide the data received from the sensor 110-1 to the optimizer 112 as represented through signal 406. The local controller 108 may also provide data 408 related to factors that influence ambient conditions of the building 102 such as occupancy patterns and external weather conditions to the optimizer 112 along with data 502 as indicated by the signal 406.

In an example, the optimizer 112 may determine the setpoints in accordance with the factors influencing the ambient condition within the building 102 or the zone 104-1 of the building 102 such as external weather conditions or occupancy and based on the data 402 as sensed by the sensor 110-1 as indicated in the block 412. The optimizer 112 may determine the setpoints based on AI models utilizing historic data related to past operation of the similar assets. The optimizer 112 may provide the setpoints 410 to the local controller 108 as represented through the signal 414.

Based on the setpoints received from the optimizer 112, the local controller 108 controls the operating parameters of the asset 106-1 through a corresponding actuator, such as the actuator 116-1, connected to the asset 106-1 to achieve the predefined ambient condition within the building or zone of the building, which may comprise sending signals to the actuator 116-1 as indicated through the signal 416. The actuator 116-1 may execute physical changes in the setting of the asset 106-1 in accordance with the operating parameters as indicated in the block 418 as indicated through signal 418a.

To manage building operations, the system 118 monitors operation of the one or more assets installed in each of the plurality of zones in the building 102, such as asset 106-1 installed in zone 104-1 of the building 102, over a period of time to determine a deviation in values of the operating parameters of the asset 106-1 from a corresponding predefined range of setpoints. The predefined range of setpoints including values of the operating parameters of the asset 106-1 predefined for the time period may be received by the system 118 from the optimizer 112 as indicated through signal 420. To monitor operation of the asset 106-1, the system 118 may receive the data 402 indicative of the operating parameters of the asset 106-1 as sensed by the sensor 110-1 and data either from the optimizer 112 as represented through the signal 420 or from the local controller 108 as represented through the signal 420a. Data 408 related to factors that influence ambient conditions of the building 102 such as occupancy patterns and external weather conditions may also be received by the system 118 along with data 402 either from the optimizer 112 as represented through the signal 420 or from the local controller 108 as represented through the signal 420a. The system 118 may compare the values of the operating parameters of the asset 106-1 with the corresponding predefined range of setpoints to determine a deviation in values of operating parameters of the asset 106-1 from a corresponding predefined range of setpoints. Based on the deviation, the system 118 may estimate a loss associated with the operation of the asset 106-1 for the time period. The loss may be expressed in terms of a monetary value that may be incurred as a result of deviation in operating parameters of the asset 106-1 from the corresponding predefined range of setpoints.

In an example, the system 118 may also determine a plurality of corrective actions to reduce the estimated loss associated with operation of the asset 106-1 occurred due to the deviation in operating parameters of the asset 106-1 from the predefined range of setpoints. The plurality of corrective action may comprise controlling the operating parameters of the asset 106-1, switching off the asset 106-1 or scheduling a maintenance operation to be carried out on the asset 106-1. The system 118 may initiate a corrective action that may be selected from amongst the plurality of corrective actions based on a reduction in the estimated loss corresponding to each of the plurality of corrective actions and a cost to implement the corrective action. To initiate a corrective action such as adjusting operating parameters of the asset or switching off the assets, the system 118 may instruct the local controller 108 directly as represented through signal 422a or through the optimizer 112 as represented through signal 422b. The optimizer 112 may in turn instruct the local controller 108 to initiate the corrective action as represented through signal 424. The local controller 108 may operate the actuator 116-1 to modify the settings of the asset 106-1 in accordance with the corrective action by sending the signal as represented through signal 426. In another example, the system 118 may operate the actuator 116-1 directly as represented through signal 422c to modify setting of the asset 106-1 in accordance with the corrective action.

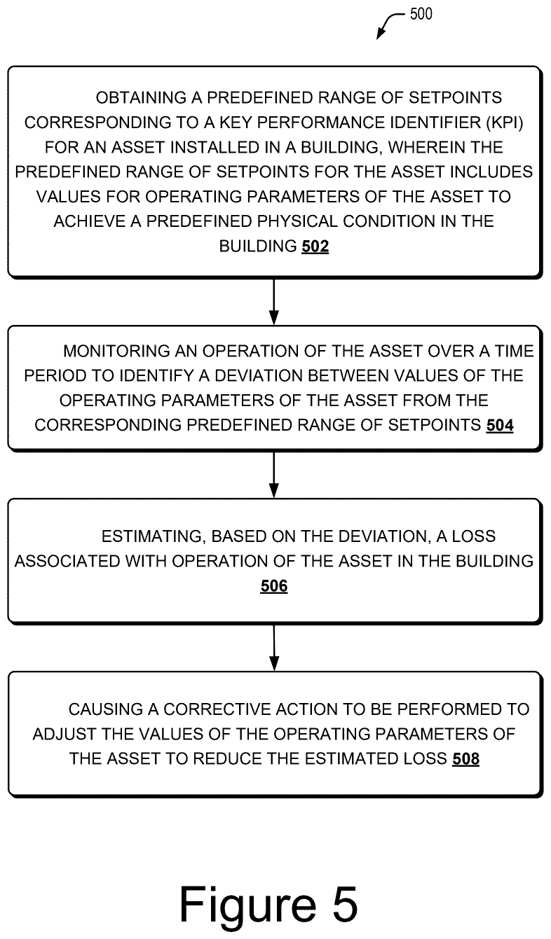

FIG. 5 illustrates a method 500 for managing building operations, according to an example. Although the method 500 may be implemented in a variety of computer-based systems, for the ease of explanation, the present description of the example method 500 to manage building operations is provided in reference to the above-described system 118.

The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or combination thereof.

It may be understood that blocks of the method 500 may be performed by programmed computing devices. The blocks of the method 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 5, at block 502, a predefined range of setpoints corresponding to a key performance identifier (KPI) for an asset installed in a building 102 are obtained. As discussed in the foregoing explanation, the predefined range of setpoints are indicative acceptable values of operating parameters of one or more assets 106-1, 106-2, . . . , and 106-n that when adhered to, lead to a predefined desired ambient condition in a building or a zone 104-1, 104-2, . . . , and 104-n thereof. The predefined ambient conditions may include temperature, humidity, air quality and lighting.

KPI(s) may be understood as a measurable objective of building operations. That is, the building operations may be carried out with different objectives such as sustainability, cost-saving, maximizing comfort of the occupant. Depending on the objective of a business operation, a corresponding KPI may be defined. For instance, if sustainability is an objective of building operations, a limit may be predefined for carbon emissions which may be referred to as corresponding KPI. Similarly, if cost saving is an objective of building operations, a limit for number of changes in valve position for a frequently operated valve may be defined, such as 5 changes per hour to prevent premature failure of the valve. Premature failure of the valve may incur a cost to replace the value. Thus, setting a limit for the number of changes in valve position may result in potential cost savings that may otherwise be incurred in the event of premature failure of valve. The setpoints corresponding to an ambient condition are thus set in accordance with the predefined KPI corresponding to building operations, and a range of values may be predefined for the setpoints to meet the KPI(s). To achieve the predefined KPI corresponding to building operations, the operating parameters of the assets 106-1, 106-2, . . . , and 106-n involved in carrying out the building operations may have to be controlled in accordance with setpoints determined based on the predefined KPI. The KPI(s) may be stored in the key performance identifier data 322. The optimizer 112 may determine the setpoints based on AI models utilizing historic data related to past operation of the one or more assets 106-1, 106-2, . . . , and 106-n.

In an example, the input module 308 of the system 118 obtains the predefined range of setpoints from the optimizer 112. Embodiments where the input module 308 of the system 118 may obtain the predefined range of setpoints from other external sources, such as a system implementing an AI model to determine such setpoints are also possible. The AI model may implement various algorithms that may use data, such as data related to the past operation of similar assets to determine the setpoint for the one or more assets 106-1, 106-2, . . . , and 106-n installed in the building 102.

At block 504, an operation of the asset 106-1, 106-2, . . . , and 106-n is monitored over a time period to identify a deviation between values of the operating parameters of the asset 106-1, 106-2, . . . , and 106-n from the corresponding predefined range of setpoints. In an example, the operation optimization module 310 of the system 118 may monitor the operation of the asset 106-1, 106-2, . . . , and 106-n. To monitor the operation of the asset 106-1, 106-2, . . . , and 106-n, the values of the operating parameters of the asset 106-1, 106-2, . . . , and 106-n that may be sensed by one or more sensors 110-1, 110-2, . . . , and 110-n associated with the asset 106-1, 106-2, . . . , and 106-n are received, for example, from the local controller 108 or the optimizer 112. Values of the operating parameters of the asset 106-1, 106-2, . . . , and 106-n may be compared with the corresponding values defined in the predefined range of setpoints to identify a deviation between both.

At block 506, based on the deviation, a loss associated with operation of the asset 106-1, 106-2, . . . , and 106-n in the building 102 may be estimated. In an example, the operation optimization module 310 of the system 118 may estimate the loss. The loss may be expressed in terms of monetary value, energy expenditure or reduction in life of the asset 106-1, 106-2, . . . , and 106-n.

For example, a schedule of operating states of assets 106-1, 106-2, . . . , and 106-n in the building 102 may dictate the operating state of lights in an office building during non-working hours to be OFF. Such scheduled duration of non-working of assets 106-1, 106-2, . . . , and 106-n may be reflected in the corresponding setpoints. However, during monitoring, operating state of the lighting system of the building may be found to be as ON. A monetary value of loss occurred may be estimated depending on a duration of time for which the operating state of the lighting system is found as ON during the scheduled non-working and based on the cost of energy required to operate the lighting system for such duration.

Having estimated the loss, at block 508, a corrective action is caused to be performed to adjust the values of the operating parameters of the asset 106-1, 106-2, . . . , and 106-n to reduce the estimated loss. For this purpose, the corrective action to reduce the estimated loss may be determined. The corrective action may comprise varying the operating parameters of the asset 106-1, 106-2, . . . , and 106-n. In example implementations, the corrective action may cause to be asset's operation to comply with the schedule of operating states of assets 106-1, 106-2, . . . , and 106-n in the building 102. Accordingly, in an example, a corrective action may comprise changing the operating parameters of an asset 106-1, 106-2, . . . , and 106-n from a switched ON to switched OFF state. The corrective action that requires adjusting values of the operating parameters of the asset 106-1, 106-2, . . . , and 106-n may be performed through actuating the corresponding actuators 116-1, 116-2, . . . , and 116-n operable to modify the setting of the asset 106-1, 106-2, . . . , and 106-n in accordance with the operating parameters, in one example. In another example, the corrective action may involve generating a notification for a field operator to turn the asset 106-1, 106-2, . . . , and 106-n off]. Examples of corrective actions may comprise scheduling maintenance operations to be carried out on the assets 106-1, 106-2, . . . , and 106-n.

The corrective action identification module 312 of the system 118 may determine the corrective action, for example, based on a cost to implement the corrective action and reduction in loss associated with the asset 106-1, 106-2, . . . , and 106-n. The corrective action implementation module 314 may cause the corrective action to be performed. Thus, the method 500 results in reduction in loss associated with operation of the asset 106-1, 106-2, . . . , and 106-n.

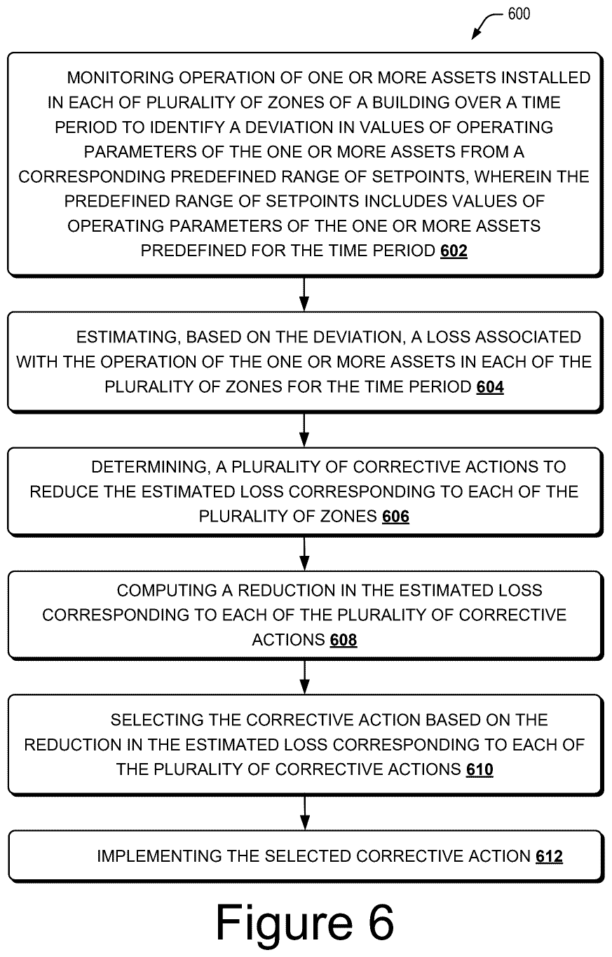

FIG. 6 illustrates a method 600 for managing building operations, according to another example of the present subject matter. Although, the method 600 may be implemented in a variety of computer-based systems such as the system 118, as is the case with method 500, for the ease of explanation, the present description of the example method 600 to manage the lifecycle of the product is provided in reference to the above-described system 118.

The method 600 may be implemented by a processor(s) or computing device(s) through any suitable hardware, non-transitory machine-readable instructions, or combination thereof. It may be understood that blocks of the method 600 may be performed by programmed computing devices such as the system 118. The blocks of the method 600 may be executed based on instructions stored in a non-transitory computer readable medium, as will be readily understood. The non-transitory computer readable medium may include, for example, digital memories, magnetic storage media, such as magnetic disks and magnetic tapes, hard drives, or optically readable digital data storage media.

The order in which the method 600 is described is not intended to be construed as a limitation, and any number of the described method blocks may be combined in any order to implement the method 600, or an alternative method.

As described above, building operations are performed to maintain and regulate ambient conditions within a building 102 or plurality of zones 104-1, 104-2, . . . , and 104-n of the building 102 in compliance with measurable KPIs. Ambient conditions may comprise temperature, humidity, lighting or air quality. To regulate the ambient conditions, operating parameters of one or more assets 106-1, 106-2, . . . , and 106-n installed in plurality of zones 104-1, 104-2, . . . , and 104-n of the building 102 may be monitored and controlled by the local controller 108 in accordance with the setpoints. The setpoints define values of the operating parameters to achieve the ambient condition that may be predefined. For example, the aforementioned optimizer 112 may define the setpoints in accordance with factors influencing the ambient condition within the building 102 or the zone 106-1, 106-2, . . . , and 106-n of the building 102 such as external weather conditions or occupancy.

At block 602, operation of the one or more assets 106-1, 106-2, . . . , and 106-n installed in each of the plurality of zones 104-1, 104-2, . . . , and 104-n of the building 102 is monitored over a time period to identify a deviation in values of operating parameters of the one or more assets 106-1, 106-2, . . . , and 106-n from a corresponding predefined range of setpoints. The predefined range of setpoints includes values of operating parameters of the one or more assets 106-1, 106-2, . . . , and 106-n predefined for the time period. In an example, to monitor the operation of the one or more assets 106-1, 106-2, . . . , and 106-n, the operation optimization module 310 of the system 118 may receive the values of the operating parameters of the one or more assets 106-1, 106-2, . . . , and 106-n in the plurality of zones 104-1, 104-2, . . . , and 104-n as sensed by the one or more sensors 110-1, 110-2, . . . , and 110-n installed in each zone 104-1, 104-2, . . . , and 104-n. The input module 308 of the system 118 may obtain the predefined range of setpoints either directly from the local controller 108 or from the optimizer 112.

For each asset 106-1, 106-2, . . . , and 106-n in a zone 104-1, 104-2, . . . , and 104-n, the operation optimization module 310 compares the values of the operating parameters of the asset 106-1, 106-2, . . . , and 106-n with the corresponding values defined in the setpoint to identify the deviation. For example, number of changes in valve position for a frequently operated valve in an air conditioning system may be defined, such as 5 changes per hour to avoid reduction in life of the valve. However, during monitoring the operation, it is found that the valve position undergo a change at a rate of 8 changes per hour, for example, due to unwarranted manual operation of the value. Thus, a deviation of 3 changes per hour in valve position may be determined. In another example, according to the setpoint, if outdoor temperature drops to a temperature defined for a zone 104-1, 104-2, . . . , and 104-n of the building 102, the operating state of a cooling system may be set to be turned OFF. If in such a case, the operating state of the cooling system is found to be ON, a deviation in operating state of the cooling system from the one defined in setpoint is identified. The deviation may continue for a period of time, for example, 2 hrs., before the cooling system is turned OFF. Such a duration of the deviation is also recorded, in an example.

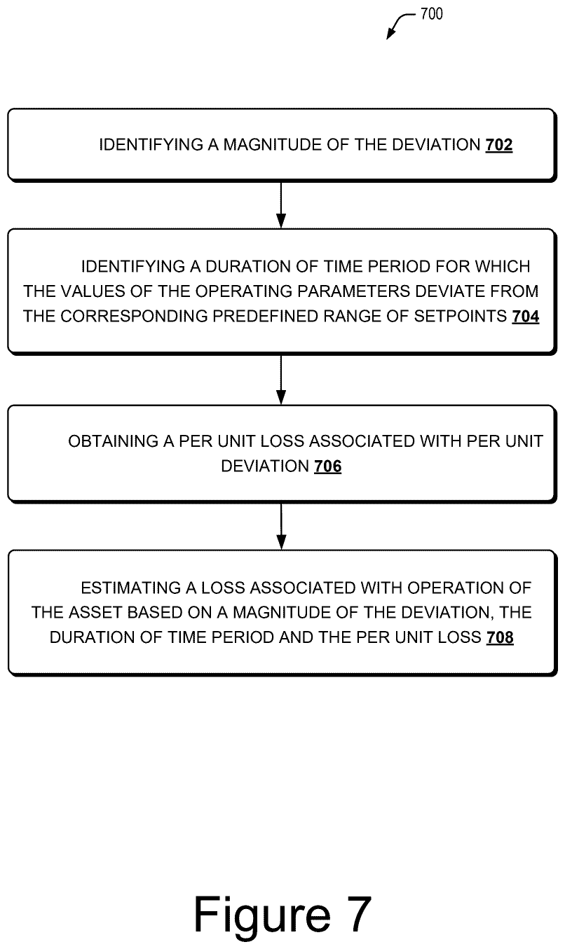

At block 604, based on the deviation, a loss associated with the operation of the one or more assets 106-1, 106-2, . . . , and 106-n in each of the plurality of zones 104-1, 104-2, . . . , and 104-n for the time period is estimated. In an example, the operation optimization module 310 may estimate the loss. The loss may be estimated in terms of monetary value, energy expenditure or reduction in life of the asset 106-1, 106-2, . . . , and 106-n. In the above example of deviation in operating state of the cooling system, the loss may be equal to a monetary value equivalent to an energy expenditure required to run the cooling system for 2 hours. The method of estimation of loss is further explained in detail with reference to FIG. 7.

Having estimated the loss associated with operation of one or more assets 106-1, 106-2, . . . , and 106-n in plurality of zones 104-1, 104-2, . . . , and 104-n of the building 102, at block 606, a plurality of corrective actions may be determined to reduce the estimated loss corresponding to each of the plurality of zones 104-1, 104-2, . . . , and 104-n. In an example, the corrective action identification module 310 may determine the plurality of corrective actions to reduce the loss associated with the operation of one or more assets 106-1, 106-2, . . . , and 106-n in each of the plurality of zones 104-1, 104-2, . . . , and 104-n. To reduce the loss associated with a zone 104-1, 104-2, . . . , and 104-n, the corrective actions may include scheduling a maintenance operation for one or more assets 106-1, 106-2, . . . , and 106-n in the zone 104-1, 104-2, . . . , and 104-n or adjusting values of operating parameters of the one or more assets 106-1, 106-2, . . . , and 106-n. For instance, in above example of cooling system, the corrective action may comprise changing the operating parameters of the cooling system in accordance with the temperature outdoors and eventually switching off the cooling system when the temperature outdoors matches the setpoint temperature. In another example, the corrective action may comprise notifying to switch off the cooling system when the outdoor temperature matches the setpoint temperature.

At block 608, a reduction in the estimated loss may be computed corresponding to each of the plurality of corrective actions. In an example, the corrective action identification module 312 may compute the reduction in estimated loss corresponding to each corrective action. Referring to the above example, an estimate of reduction in loss attributable to changing the operating parameters of the cooling system in proportion to the temperature outdoor and similarly an estimate of reduction in loss attributable to switching off the cooling system when the outdoor temperature matches the setpoint temperature may be computed.

At block 610, a corrective action from amongst the plurality of corrective action may be selected based on the reduction in the estimated loss corresponding to each of the plurality of corrective actions, for example, by the corrective action identification module 312. In an example, the corrective action may be selected based on a cost to implement each of the plurality of the corrective actions and monetary value of the reduction associated with the corrective actions. A corrective action which minimizes the loss and is cost effective to implement may be selected.

At block 612, the selected corrective action may be implemented. In an example, the corrective action implementation module 314 may implement the selected corrective action. To implement the selected corrective action, the corrective action implementation module 314 may instruct the optimizer 112 or the local controller 108 to initiate the corrective action. For instance, if the selected corrective action comprises adjusting operating parameters of an asset 106-1, 106-2, . . . , and 106-n, then the local controller 108 may be instructed to operate the corresponding actuator 116-1, 116-2, . . . , and 116-n to modify the setting of the asset 106-1, 106-2, . . . , and 106-n according to the adjusted operating parameters. Alternatively, the corrective action implementation module 314 may directly operate the actuator 116-1, 116-2, . . . , and 116-n. If the corrective action is scheduling a maintenance operation, the corrective action implementation module 314 may notify an operator about the schedule through sending e-mail or message to a registered e-mail-id or phone number.

FIG. 7 illustrates a method 700 for estimating a loss associated with operation of an asset installed in a building, according to an example. In an embodiment, the method 700 for estimating the loss, comprises steps that may, in any sequence or combination, be carried out to accomplish the function as described in block 604 of the above-described method 600 for managing building operations.

Although the method 700 for estimating the loss may be performed by any computing system, for the ease of explanation, the method 700 is herein explained in reference to the system 118. Accordingly, in the examples provided in reference to method 700, the operation optimization module 310 of the system 118 may perform the steps of the method 700.

Referring to FIG. 7, at block 702, to estimate the loss associated with operation of the asset 106-1, 106-2, . . . , and 106-n installed in the building 102 or a zone 104-1, 104-2, . . . , and 104-n of the building 102, a magnitude of deviation in values of the operating parameters of the asset 106-1, 106-2, . . . , and 106-n from the corresponding predefined range of setpoints may be identified. In an example, to maintain an ambient temperature, for example, 25° C. in the building 102 or a zone 104-1, 104-2, . . . , and 104-n of the building 102, temperature setting in the asset 106-1, 106-2, . . . , and 106-n designated for maintaining the temperature, for example, a thermostat associated with an HVAC system may be defined. If during monitoring operation of the asset 106-1, 106-2, . . . , and 106-n, the temperature is found to be 20° C., i.e., deviated from the temperature, i.e., 25° C. as predefined in the setpoint, a magnitude of the deviation therebetween is 5° C. In another example, a time expected from an asset 106-1, 106-2, . . . , and 106-n such as the HVAC system to reach a target value, e.g., a temperature of 25° C. may be defined in the setpoint. In such cases, a deviation in an amount of time taken by the asset 106-1, 106-2, . . . , and 106-n to reach the corresponding predefined range of setpoint from an expected amount of time may be identified.

At block 704, a duration of time period for which the values of the operating parameters deviate from the corresponding predefined range of setpoints may be identified, for example, by the operation optimization module 310. For instance, in the above example of deviation of 5° C. in temperature setting, it may be identified that the temperature deviated from the value defined in the setpoint by 5° C. for a duration of 5 hours. In the example of deviation in the amount of time taken by the asset 106-1, 106-2, . . . , and 106-n to reach the corresponding predefined range of setpoint, extra time taken by the asset 106-1, 106-2, . . . , and 106-n may be computed or identified as 5 min. In another example, if an outdoor temperature reaches a value defined in the setpoint for temperature of the building 102 or a zone 104-1, 104-2, . . . , and 104-n of the building 102, an operating state of the cooling or heating system installed in the building or 102 the zone 104-1, 104-2, . . . , and 104-n of the building may be defined as switched off in the setpoint. However, the cooling or heating system is found to be switched on. In such cases, the duration of time for which the asset 106-1, 106-2, . . . , and 106-n operated unnecessarily may be identified. In some cases, a schedule for operation of the asset 106-1, 106-2, . . . , and 106-n, for example, operating hours for an HVAC system installed in a zone 104-1, 104-2, . . . , and 104-n of an office building, may be defined in the setpoint. In such cases, a non-compliance with the scheduled operating time predefined for the asset 106-1, 106-2, . . . , and 106-n may be identified. That is the amount of time for which the asset 106-1, 106-2, . . . , and 106-n operated beyond the scheduled operating time may be identified.

At block 706, a unit loss associated with per unit deviation may be obtained, for example, by the operation optimization module 310. As described previously, for a unit deviation, a loss may be predefined using an AI model or statistical techniques that may utilize historic data related to operation of the similar asset 106-1, 106-2, . . . , and 106-n to determine the same. A system or the optimizer 112 may implement such model and techniques and provide the unit loss to the input module 308 of the system 118 which may provide the same to the operation optimization module 310. The operation optimization module 310 may also compute unit loss using such AI model and statistical techniques. In another example, unit loss may be provided as input to the input module 308 by a user manually. Unit loss may be expressed in terms of a monetary value, or an energy or power required for per unit deviation. For instance, 1° C. of deviation in temperature may require, for example, 1 kWh of energy. In case of the above example of working of heating or cooling system during a period of matching outdoor and indoor temperatures, the unit loss may be equivalent to power required for the operation of heating or cooling system for a unit time period such as 1 hr.

At block 708, the loss associated with operation of the asset 106-1, 106-2, . . . , and 106-n may be estimated based on the magnitude of the deviation, the duration of time period and the unit loss. The loss may be estimated in terms of monetary value or energy expenditure or reduction in life of the asset 106-1, 106-2, . . . , and 106-n. For instance, in case of the above example, 5° C. of deviation in temperature of the zone 104-1, 104-2, . . . , and 104-n for a period of 5 hr may result in a loss of 25 kWh of energy which may also be translated into an equivalent monetary value as per a tariff of energy usage. In case of the above example of working of heating or cooling system during a period of matching outdoor and indoor temperatures, the loss may be estimated based on the unit loss associated with operation of the heating and cooling system for a unit time period and a duration of time period for which the heating and cooling system remain working. In the above-discussed example of non-compliance with scheduled operating time, the loss may be estimated based on a time required for which the asset 106-1, 106-2, . . . , and 106-n operated beyond the scheduled operating time and a unit loss equivalent to amount to energy or power required to operate the asset 106-1, 106-2, . . . , and 106-n for a unit time period. In case of above example of deviation in the amount of time taken by the asset 106-1, 106-2, . . . , and 106-n to reach the corresponding predefined range of setpoint, the loss may be estimated based on, the deviation in the amount of time taken by the asset 106-1, 106-2, . . . , and 106-n to reach the corresponding predefined range of setpoint from an expected amount of time and the unit loss equivalent to amount to energy or power required to operate the asset 106-1, 106-2, . . . , and 106-n for a unit time period. The loss thus expressed in terms of energy or power in each case may be translated into equivalent monetary value based on a tariff of energy usage.

In another example the loss may be expressed in terms of a reduction in life of the asset 106-1, 106-2, . . . , and 106-n. For example, a limit for number of changes in valve position for a frequently operated valve in an air conditioning system may be defined, such as 5 changes per hour to avoid reduction in life of the valve. However, during monitoring the operation, it is found that the valve position undergoes a change at a rate of 6 changes per hour, for example, due to unwanted manual operation of the valve. Thus, a deviation of 1 change per hour in valve position may result in a loss in lifetime of the valve. The life of the valve may be dependent on the number of changes that the valve may undergo during its lifetime, e.g., 10M changes which may be equivalent to approximately 23 years if the valve operated as per the limit defined in setpoint. The reduction in life of the valve in the above case may be approximately 4 years.

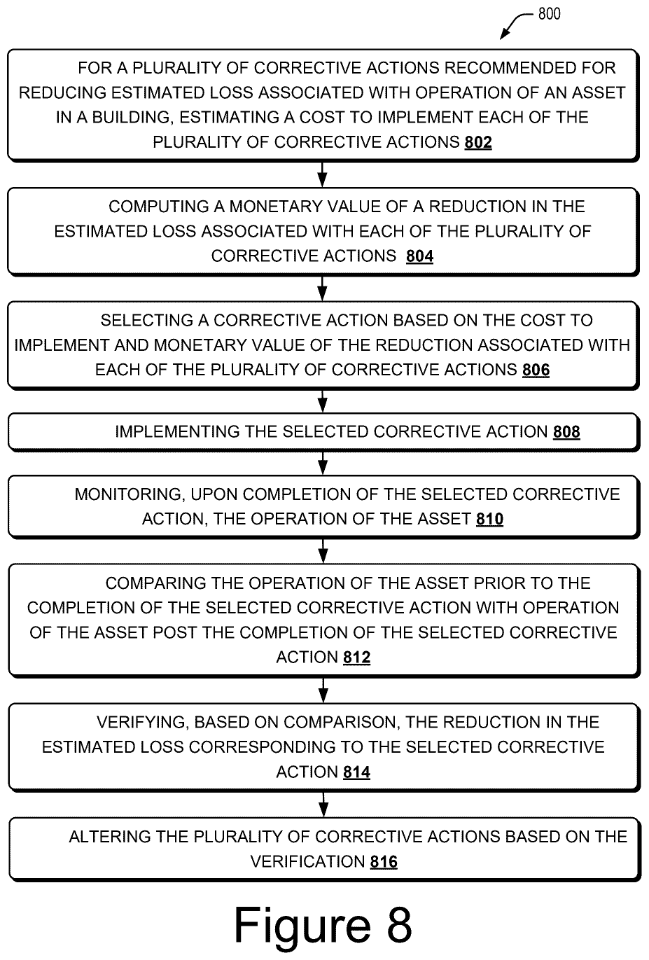

FIG. 8 illustrates a method 800 for selection and implementation of a corrective action to reduce a loss associated with operation of an asset installed in a building, according to an example of the present subject matter. Although, the method 800 may be implemented in a variety of computer-based systems, as is the case with method 600, for the ease of explanation, the method 800 is described in reference to above-described system 118.

The method 800 may be implemented by a processor(s) or computing device(s) through any suitable hardware, non-transitory machine-readable instructions, or combination thereof. It may be understood that blocks of the method 800 may be performed by programmed computing devices such as the system 118. The blocks of the method 800 may be executed based on instructions stored in a non-transitory computer readable medium, as will be readily understood. The non-transitory computer readable medium may include, for example, digital memories, magnetic storage media, such as magnetic disks and magnetic tapes, hard drives, or optically readable digital data storage media.

To reduce a loss associated with operation of an asset 106-1, 106-2, . . . , and 106-n installed in a building 102 as estimated by the operation optimization module 310 of system 118 using the method 700, a plurality of corrective actions may be determined, for example, by the corrective action identification module 312 of the system 118. The plurality of corrective actions may include scheduling a maintenance operation that may be carried out on the asset 106-1, 106-2, . . . , and 106-n, adjusting operating parameters of the asset 106-1, 106-2, . . . , and 106-n, switching off or on the asset 106-1, 106-2, . . . , and 106-n and others actions that may reduce the loss associated with operation of the asset 106-1, 106-2, . . . , and 106-n.

Referring to FIG. 8, at block 802, for a plurality of corrective actions recommended for reducing estimated loss associated with operation of an asset 106-1, 106-2, . . . , and 106-n in a building 102, a cost to implement each of the plurality of corrective actions may be estimated, for example, by the corrective action identification module 312. In an example, if the corrective action comprises a maintenance operation to be carried out, then the cost to implement the corrective action may comprise an amount to be paid to service personnels, cost of the asset 106-1, 106-2, . . . , and 106-n, if the asset 106-1, 106-2, . . . , and 106-n needs to be replaced as part of the maintenance operation or cost of one or more component of the asset 106-1, 106-2, . . . , and 106-n, that may need to be replaced. If other resources are needed for the maintenance, cost of the same may be included in the cost to implement the corrective action.

At block 804, a monetary value of a reduction in the estimated loss associated with each of the plurality of corrective actions may be computed, for example, by the corrective action identification module 312. In an example, an HVAC system is found to have taken an extra time of 5 min to reach a temperature than the expected time defined in the setpoints, and corrective action requires replacement of a faulty valve in the HVAC system. The reduction in loss with implementing the corrective action may be an energy required by the HVAC system to run for the extra time of 5 min. The reduction in loss thus expressed in terms of energy may be translated into equivalent monetary value based on a tariff of energy usage.

At block 806, a corrective action may be selected from amongst the plurality of corrective actions based on the cost to implement and monetary value of the reduction associated with each of the plurality of corrective actions, for example, by the corrective action identification module 312. A corrective action which results in maximum reduction in loss with the least amount of cost incurred in implementation may be selected. In case of example discussed above, if the loss that may be accrued as a result of operation of HVAC system with faulty valve for a duration, for example, equivalent to remaining lifetime of valve is considerably less than the cost required to replace the valve, than the corrective action may not be selected.

Once, the corrective is selected, at block 808, the corrective action may be implemented, for example, by the corrective action implementation module 314. For instance, if the corrective action is adjusting parameters of the asset 106-1, 106-2, . . . , and 106-n, the corrective action implementation module 314 may operate corresponding actuators 116-1, 116-2, . . . , and 116-n to adjust the parameters of the asset 106-1, 106-2, . . . , and 106-n or may instruct the optimizer 112 or the local controller 108 to operate the actuators 116-1, 116-2, . . . , and 116-n. In another example, to implement a corrective action comprising maintenance of the asset 106-1, 106-2, . . . , and 106-n, the corrective action implementation module 314 may inform a service personnel or building operations manager about a schedule of the maintenance.

At block, 810, upon completion of the selected corrective action, the operation of the asset 106-1, 106-2, . . . , and 106-n may be monitored, for example, by the operation optimization module 310 in accordance with the step 602 of above-described method 600. Proceeding to block 812, the operation of the asset 106-1, 106-2, . . . , and 106-n prior to the completion of the selected corrective action is compared with operation of the asset 106-1, 106-2, . . . , and 106-n post the completion of the selected corrective action. At block 814, based on comparison, the reduction in the estimated loss corresponding to the selected corrective action may be verified by the corrective action identification module 312. For example, after implementation of the corrective action of adjusting operating parameters of the asset 106-1, 106-2, . . . , and 106-n, it may be verified whether the loss that may have been occurred as a result of deviation in values of the operating parameters of the asset 106-1, 106-2, . . . , and 106-n from the values defined in the setpoints is reduced or not.

At block 816, the plurality of corrective actions may be altered based on the verification by the corrective action identification module 312. For instance, if based on the verification, it is found that loss is also occurring post completion of the selected corrective action, i.e., adjusting parameters of the asset 106-1, 106-2, . . . , and 106-n, then another corrective action may be selected from amongst the plurality of corrective actions.

The techniques described herein also involve providing an indication of the cost that may be incurred in implementation of a corrective action and a return on investment associated with implementation of a corrective action. This enables selection of an appropriate corrective action in cases where several alternative corrective actions are feasible to be implemented. The techniques may thus enable a stakeholder to select a corrective action that may be most pertinent based on the associated cost and the reduction in loss that may be achieved through the implementation of the corrective action or prioritize the different corrective actions that may be feasible.

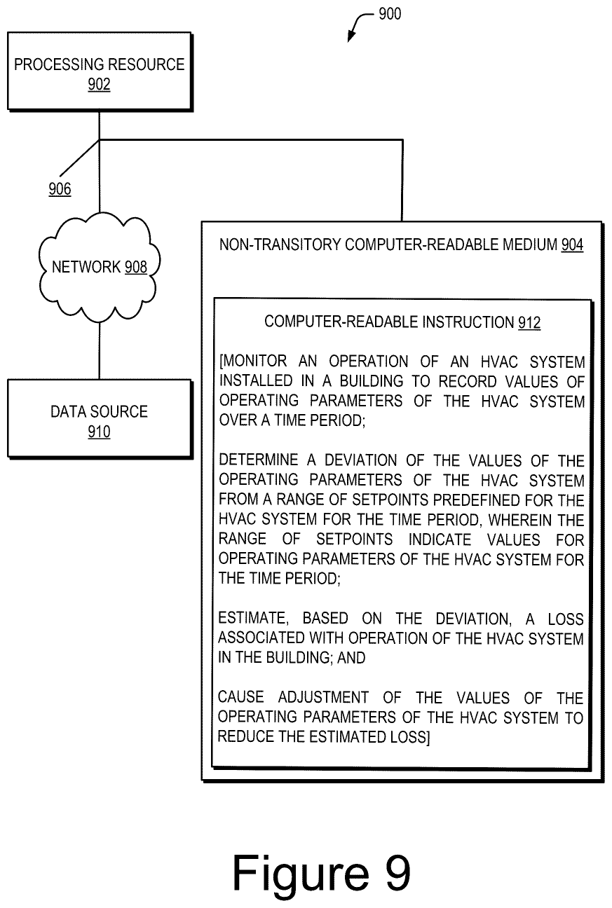

FIG. 9 illustrates a computing environment 900 for managing building operations, according to an example. In an example implementation, the computing environment 900 may comprise a computing device, such as the above-described system 118. The computing environment 900 includes a processing resource 902 communicatively coupled to the non-transitory computer-readable medium 904 through a communication link 906. In an example, the processing resource 902 may be a processor of the computing device, such as the processor 202 of the system 118, that fetches and executes computer-readable instructions from the non-transitory computer-readable medium 904.

The non-transitory computer-readable medium 904 can be, for example, an internal memory device or an external memory device. In an example implementation, the communication link 906 may be a direct communication link, such as any memory read/write interface. In another example implementation, the communication link 906 may be an indirect communication link, such as a network interface. In such a case, the processing resource 902 can access the non-transitory computer-readable medium 904 through a network 908. The network 908 may be a single network or a combination of multiple networks and may use a variety of different communication protocols.

The processing resource 902 and the non-transitory computer-readable medium 904 may also be communicatively coupled to data sources 910. In an example implementation, the non-transitory computer-readable medium 904 comprises executable instructions 912 for managing building operations. Building operations are performed to maintain and regulate ambient conditions such as temperature, humidity, air quality or lighting within a building.

In an example, the instructions 912 cause the processing resource 902 monitor an operation of an HVAC system installed in a building 102 to record values of operating parameters of the HVAC system over a time period. In an example, the instructions 912 may cause the processing resource 902 to receive data indicative of values of operating parameters of the HVAC system over the time period as sensed by one or more sensors 110-1, 110-2, . . . , and 110-n connected to the HVAC system. In an example, the operating parameters of the HVAC system may include the supply water, the air temperature, and/or the air speed, among others, associated with various components of the HVAC system, that may be sensed, for example, by a corresponding sensor 110-1, 110-2, . . . , and 110-n.

In an example, the instructions 912 may cause the processing resource 902 to determine a deviation of the values of the operating parameters of the HVAC system from a range of setpoints predefined for the HVAC system for the time period. The range of setpoints indicates values of the operating parameters of the HVAC system for the time period. In an example, the setpoints serve as targets to achieve and maintain a desired ambient condition in the building, for example, through regulation of assets such as the HVAC system installed in the building. The instructions 912 may cause the processing resource 902 to obtain the range of setpoints predefined for the HVAC system.

In an example, the instructions 912 may cause the processing resource 902 to estimate, based on the deviation, a loss associated with operation of the HVAC system in the building. The loss may be expressed in terms of a monetary value, reduction in life of an asset or energy expenditure. In an example implementation, to estimate the loss, the instructions 912 may cause the processing resource 902 to determine a magnitude of deviation in temperature of an area of the building maintained by the HVAC system from a temperature as defined in the corresponding predefined range of setpoints and determine a duration of time for which the temperature of the area deviates. For example, a temperature of an area of the building may be defined in the setpoints as 25° C., while the temperature is found to be 20° C. resulting in a deviation of 5° C. The loss that may occur as a result of deviation in temperature during operation of the HVAC system may be estimated based on the magnitude of deviation, i.e., 5° C. and a duration for which the temperature of the area deviates, e.g., 5 hrs.

Having estimated the loss, in an example, the instructions 912 cause the processing resource 902 to cause adjustment of the values of the operating parameters of the HVAC system to reduce the estimated loss. In case of above example, the temperature setting may be adjusted to reduce the loss.

Thus, the methods and systems of the present subject matter provide for managing building operations. Although implementations of managing building operations have been described in a language specific to structural features and/or methods, it is to be understood that the appended claims are not necessarily limited to the specific features or methods described. Rather, the specific features and methods are disclosed as example implementations of managing building operations.

1. A method for managing building operations, comprising:
obtaining a predefined range of setpoints corresponding to a key performance identifier (KPI) for an asset installed in a building, wherein the predefined range of setpoints for the asset includes values for operating parameters of the asset to achieve a predefined ambient condition in the building;
monitoring an operation of the asset over a time period to identify a deviation between values of the operating parameters of the asset from the corresponding predefined range of setpoints;
estimating, based on the deviation, a loss associated with operation of the asset in the building; and
causing a corrective action to be performed to adjust the values of the operating parameters of the asset to reduce the estimated loss.

2. The method as claimed in claim 1 further comprising computing, corresponding to the corrective action, a monetary value of the reduction in the estimated loss.

3. The method as claimed in claim 1, wherein estimating the loss comprises computing monetary loss associated with operation of the asset in the building for a predetermined duration of time in future.

4. The method as claimed in claim 1, wherein the method further comprises:
monitoring, operation of each of a plurality of assets installed in the building over the period of time;
estimating, based on the operation of each of the plurality of assets, an aggregated loss associated with the operation of a subset of the plurality of assets.

5. The method as claimed in claim 1, wherein the corrective action comprises at least one of scheduling a maintenance operation to be carried out on the asset, and varying the operating parameters of the asset.

6. The method as claimed in claim 1, wherein the method further comprises
recommending a plurality of corrective actions to reduce the estimated loss;
indicating a monetary value of the reduction in the estimated loss corresponding to each of the plurality of corrective actions; and
selecting the corrective action to be performed based on the monetary value of the reduction in the estimated loss corresponding to each of the plurality of corrective actions.

7. The method as claimed in claim 1, wherein estimating the loss comprises:
identifying a magnitude of the deviation; and
identifying a duration of the time period during which the values of the operating parameters deviate from the corresponding predefined range of setpoints.

8. The method as claimed in claim 1, wherein estimating the loss comprises determining the loss based on non-compliance with a scheduled operating time predefined for the asset.

9. The method as claimed in claim 1, wherein estimating the loss comprises determining a deviation in amount of time taken by the asset to reach the corresponding predefined range of setpoint from an expected amount of time.

10. A non-transitory computer-readable medium comprising instructions executable by a processing resource to:
monitor an operation of an HVAC system installed in a building to record values of operating parameters of the HVAC system over a time period;
determine a deviation of the values of the operating parameters of the HVAC system from a range of setpoints predefined for the HVAC system for the time period, wherein the range of setpoints indicate values for operating parameters of the HVAC system for the time period;
estimate, based on the deviation, a loss associated with operation of the HVAC system in the building; and
cause adjustment of the values of the operating parameters of the HVAC system to reduce the estimated loss.

11. The non-transitory computer-readable medium as claimed in claim 10, wherein to estimate the loss, the non-transitory computer-readable medium further comprises instructions executable by the processing resource to determine a magnitude of deviation in temperature of an area of the building maintained by the HVAC system from a temperature as defined in the corresponding predefined range of setpoints and determine a duration of time for which the temperature of the area deviates.

12. A system for managing building operations, the system comprising:
a processor to:
monitor an operation of one or more assets installed in each of plurality of zones in a building over a period of time to determine a deviation in values of operating parameters of the one or more assets from a corresponding predefined range of setpoints, wherein the predefined range of setpoints includes values of operating parameters of the one or more assets predefined for the time period;
estimate, based on the deviation, a loss associated with the operation of the one or more assets in each of the plurality of zones for the time period;
determine a plurality of corrective actions to reduce the estimated loss corresponding to each of the plurality of zones; and
initiate a corrective action selected from amongst the plurality of corrective actions, the corrective action being selected based on a reduction in the estimated loss corresponding to each of the plurality of corrective actions.

13. The system as claimed in claim 12, wherein the plurality of corrective action comprises controlling operating parameters of at least one of the assets, switching off least one of the assets or scheduling a maintenance operation to be carried out on at least one of the assets.

14. The system as claimed in claim 12, wherein the processor is to compute, corresponding to the corrective action, a monetary value of the reduction in the estimated loss.

15. The system as claimed in claim 12, wherein to select the corrective action from amongst the plurality of corrective actions, the processor is to estimate a cost to implement each of the plurality of corrective actions.

16. The system as claimed in claim 12, wherein to estimate the loss associated with the operation of the one or more assets, the processor is to:
identify a magnitude of the deviation; and
identify a duration of the time period during which the values of the operating parameters deviate from the corresponding predefined range of setpoints.

17. The system as claimed in claim 12, wherein to select the corrective action from amongst the plurality of corrective actions, the processor is to compute a reduction in the estimated loss associated with implementing each of the plurality of corrective actions for a predetermined duration of time in future.

18. The system as claimed in claim 12, wherein the processor is to identify, based on the loss associated with the operation of the one or more assets in each of the plurality of zones, a zone corresponding to a highest loss.

19. The system as claimed in claim 12, wherein the processor is to compute, based on the loss associated with the operation of the one or more assets in each of the plurality of zones, an aggregated loss associated with the operation of a subset of the plurality of zones in the building.

20. The system as claimed in claim 12, wherein the processor is to:
monitor, upon completion of the selected corrective action, the operation of each of the one or more assets; and
determine, based on comparison of the operation of each of the one or more assets prior to the completion of the selected corrective action with operation of each of the one or more assets post the completion of the selected corrective action, the reduction in the estimated loss corresponding to selected corrective action.
